(19) United States
(12) Patent Application Publication
(10) Pub. No.: US 2025/0324005 A1
(43) Pub. Date: Oct. 16, 2025

(54) IMAGE FORMING APPARATUS ON WHICH SUBSCRIPTION AGREEMENT IS CONCLUDED, SYSTEM, METHOD OF CONTROLLING IMAGE FORMING APPARATUS, AND STORAGE MEDIUM

(71) Applicant: CANON KABUSHIKI KAISHA, Tokyo (JP)

(72) Inventor: NAOKI MORITA, Chiba (JP)

(21) Appl. No.: 19/173,494

(22) Filed: Apr. 8, 2025

(30) Foreign Application Priority Data
Apr. 11, 2024 (JP) 2024-064025

(51) Int. Cl. H04N 1/00; G03G 15/00; H04N 1/44

(52) U.S. Cl. CPC H04N 1/00474; G03G 15/502; G03G 15/5091; H04N 1/00244; H04N 1/00344; H04N 1/00413; H04N 1/4413; H04N 2201/0094

(57) ABSTRACT

An image forming apparatus that acquires agreement information managed by a server and receives provision of a service according to the agreement information includes at least one memory storing a program, and at least one processor that executes the stored program, which cause the at least one processor to update use state information of the image forming apparatus, extract partial information from the agreement information and the use state information, and perform display of the partial information on a function selection screen for selecting a function of the image forming apparatus.

### BACKGROUND

### Field of the Disclosure

The present disclosure relates to an image forming apparatus on which a subscription agreement is concluded, a system, a method of controlling the image forming apparatus, and a storage medium.

### Description of the Related Art

In recent years, with the introduction of a subscription agreement, a service has become widespread, for renting a device main body and consumables to a user who has concluded an agreement for the service and providing a flat-rate service without generation of initial costs and maintenance costs. In this agreement-based flat-rate service, an image forming apparatus communicates with a management server to acquire agreement information indicating a status of the service agreement and so forth from the server and controls the image forming apparatus according to the acquired agreement information. The control of the image forming apparatus, which is performed in this case, includes, for example, control of restricting use of the image forming apparatus until service authentication for confirming that the service agreement has been concluded is completed.

Further, in Japanese Laid-Open Patent Publication (Kokai) No. H09-90825, there has been proposed a technique for restricting use of an image forming apparatus when the number of copied sheets exceeds the agreed number of copies. Further, a mechanism has already been put into practice which enables a user to view and edit the agreement information managed by a server in a form capable of being viewed by using a browser, such as a dashboard. This enables the user to view the agreement information from an information processing apparatus, such as a personal computer, at any time and change the agreement information as required.

Further, even with an image forming apparatus which does not have a browser, it is possible to acquire the agreement information managed by the server in the form of the dashboard and view the agreement information by displaying the acquired agreement information on a display device. However, the display device of the image forming apparatus has its display space limitation, and hence the display of the agreement information, which is equivalent to the dashboard, cannot be always performed. Therefore, in a case where a user performs copying or USB printing using the image forming apparatus, if the user performs printing while being aware of the use state of the image forming apparatus without viewing the information in the form of the dashboard, there is a fear that the user suffers an unexpected disadvantage. For example, a situation can be caused in which, as a result of copying a document which is not important, the number of printed sheets in a month reaches its upper limit, and copying of an important document which is scheduled to be copied thereafter is impossible.

### SUMMARY

The present disclosure provides a mechanism that is capable of preventing a user from suffering an unexpected disadvantage when using an image forming apparatus on which a subscription agreement has been concluded.

In an aspect of the present disclosure, there is provided an image forming apparatus that acquires agreement information managed by a server and receives provision of a service according to the agreement information includes at least one memory storing a program, and at least one processor that executes the stored program, which cause the at least one processor to update use state information of the image forming apparatus, extract partial information from the agreement information and the use state information, and perform display of the partial information on a function selection screen for selecting a function of the image forming apparatus.

According to the present disclosure, it is possible to prevent a user from suffering an unexpected disadvantage when using an image forming apparatus on which a subscription agreement has been concluded.

Further features of the present disclosure will become apparent from the following description of exemplary embodiments (with reference to the attached drawings).

### BRIEF DESCRIPTION OF THE DRAWINGS

FIG. 1 is a diagram showing an example of the overall configuration of an information processing system according to a first embodiment.

FIG. 2 is a diagram showing an example of a hardware configuration of an image forming apparatus in the first embodiment.

FIG. 3 is a diagram showing an example of a schematic hardware configuration of a device management server in the first embodiment.

FIG. 4 is a diagram showing an example of a schematic hardware configuration of a service management server in the first embodiment.

FIG. 5 is a diagram showing an example of a schematic hardware configuration of an information processing apparatus in the first embodiment.

FIG. 6 is a sequence diagram in the first embodiment, which shows a process in which after a user has concluded a service agreement, the service of the service agreement becomes available in the image forming apparatus, and further, part of agreement information and the like of the service agreement becomes capable of being displayed on the image forming apparatus.

FIG. 7 is a diagram showing an example of the agreement information of the service agreement in the first embodiment.

FIG. 8 is a sequence diagram in the first embodiment, which shows a process until the dashboard display is performed by the information processing apparatus when printing is performed by the image forming apparatus during the service agreement period.

FIG. 9 is a diagram showing an example of use state information in the first embodiment.

FIGS. 10A and 10B are diagrams each showing an example of partial display of the use state information and the agreement information in the first embodiment.

FIG. 11 is a flowchart of a process from execution of printing to partial information display processing in the image forming apparatus in the first embodiment.

FIG. 12 is a sequence diagram concerning change of the agreement information of the service agreement in the first embodiment.

FIGS. 13A to 13F are diagrams each showing an example of a screen aimed to display further detailed information than the partial display of the use state information and the agreement information in the first embodiment.

FIG. 14 is a sequence diagram associated with acquisition of the agreement information from the device management server in the first embodiment.

FIGS. 15A and 15B are diagrams each showing an example of agreement information of one of a plurality of service agreements in a second embodiment.

FIG. 16 is a diagram showing an example of account information in the second embodiment.

FIG. 17 is a sequence diagram of a process from an account information operation request to partial information display processing in the second embodiment.

FIGS. 18A and 18B are diagrams showing respective examples of a login screen and a state confirmation screen in the second embodiment.

FIGS. 19A to 19C are diagrams each showing an example of partial display of the use state information and each agreement information in a third embodiment.

FIG. 20 is a diagram showing an example of agreement correspondence display association setting in the third embodiment.

FIG. 21 is a flowchart of a process from execution of printing to partial information display processing in the third embodiment.

FIGS. 22A and 22B are diagrams each showing an example of a screen displayed in a case where part of the use state information and the agreement information is displayed on a status line in a variation.

FIG. 23 is a diagram showing an example of a popup screen in the variation.

### DESCRIPTION OF THE EMBODIMENTS

The present disclosure will now be described in detail below with reference to the accompanying drawings showing embodiments thereof. However, not all combinations of features described in the embodiments are absolutely essential to the solution according to the disclosure. Further, the configurations described in the following embodiments are given only by way of example, and are by no means intended to limit the scope of the present disclosure. For example, each component of the present disclosure can be replaced by a desired component which can exhibit the same function. Further, a desired component can be added. Further, two or more desired components (features) of the embodiments can be combined.

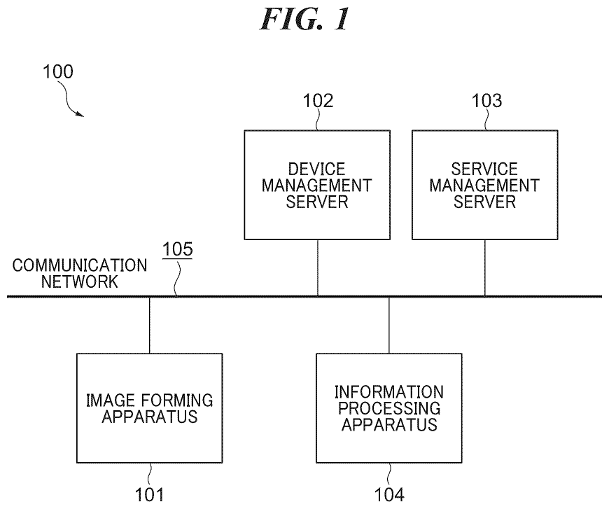

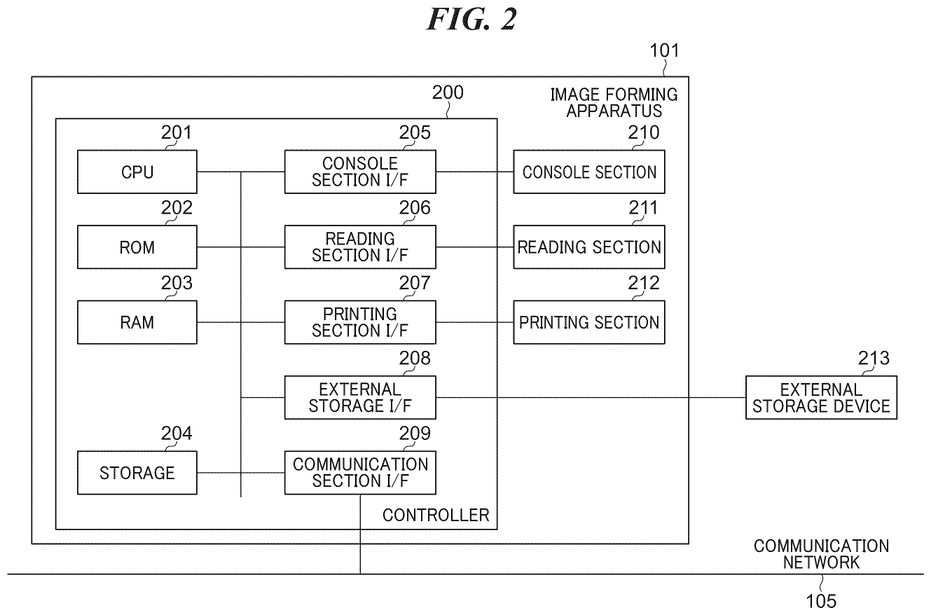

A first embodiment will be described below with reference to FIGS. 1 to 14. FIG. 1 is a diagram showing an example of the overall configuration of an information processing system according to the first embodiment. The information process system (system), denoted by reference numeral 100, includes an image forming apparatus 101, a device management server 102 (server), a service management server 103 (server), and an information processing apparatus 104. The image forming apparatus 101, the device management server 102, the service management server 103, and the information processing apparatus 104 are communicably connected via a communication network 105, such as the Internet. The image forming apparatus 101 stores agreement information in a storage (denoted by reference numeral 204 in FIG. 2), described hereinafter, and the image forming apparatus 101 is controlled according to the stored agreement information.

The image forming apparatus 101 receives the agreement information by communicating with the device management server 102 via the communication network 105. Further, the image forming apparatus 101 transmits use state information, a variety of setting information, and so forth of the image forming apparatus 101 in response to a request from the device management server 102 or the information processing apparatus 104. Note that in the first embodiment, as the image forming apparatus 101, a multifunction peripheral having a print function, a scan function, a copy function, and so forth will be described by way of example. However, the image forming apparatus 101 is not limited to the multifunction peripheral but can be an apparatus having one or a plurality of functions out of the print function, the copy function, the scan function, a FAX function, and so forth.

The device management server 102 holds the agreement information notified from the service management server 103 and provides the agreement information to the image forming apparatus 101 based on the agreement information held therein. Further, the device management server 102 holds the use state information and the variety of setting information, which are notified from the image forming apparatus 101, and provides use state information and a variety of setting information to the service management server 103 based on the use state information and the variety of setting information held therein. The information processing apparatus 104 requests the image forming apparatus 101 to transmit the use state information and the variety of setting information of the image forming apparatus 101 and receives the use state information and the variety of setting information of the image forming apparatus 101 from the image forming apparatus 101.

Then, the information processing apparatus 104 can display the use state information and the variety of setting information of the image forming apparatus 101, which are received from the image forming apparatus 101, on a variety of browsers, and further, can perform e.g. changing the setting information. Further, the information processing apparatus 104 performs user authentication with the service management server 103 and thereby requests agreement information on a service agreement concluded by the authenticated user to the service management server 103 and receives the requested agreement information. Then, the information processing apparatus 104 can display the agreement information received from the service management server 103 on the variety of browsers, and further, can perform an inquiry, a variety of requests, and so forth, concerning the service agreement.

The communication network 105 can be wirelessly connected to an access point (not shown) insofar as the communication network 105 is configured to be capable of transmitting image data and so forth. For communication between the image forming apparatus 101, the device management server 102, the service management server 103, and the information processing apparatus 104, a communication protocol, such as the Hypertext Transfer Protocol (hereinafter referred to as the “HTTP”), is used. As the method of controlling communication between the image forming apparatus 101, the device management server 102, the service management server 103, and the information processing apparatus 104, a known method is used. Note that communication between the image forming apparatus 101 and the service management server 103 is performed via the device management server 102, but this is not limitative. For example, the image forming apparatus 101 and the service management server 103 can directly transfer the agreement information and the like via the communication network 105. Note that details of the agreement information and details of the control of the image forming apparatus 101, which is performed according to the agreement information, will be described hereinafter.

FIG. 2 is a diagram showing an example of a hardware configuration of the image forming apparatus 101. The image forming apparatus 101 has a controller 200. The controller 200 includes a central processing unit (CPU) 201, a read only memory (ROM) 202, a random access memory (RAM) 203, the storage 204, a console section interface (I/F) 205, a reading section I/F 206, a printing section I/F 207, an external storage I/F 208, and a communication section I/F 209. Further, the image forming apparatus 101 has a console section 210, a reading section 211, and a printing section 212. The controller 200 controls the overall operation of the image forming apparatus 101 by the CPU 201 and so forth. The CPU 201 is a computer that performs a variety of controls, such as reading control and printing control, by loading control programs stored in the ROM 202 or the storage 204 into the RAM 203 and executing the loaded programs.

The ROM 202 stores the control programs and so forth. Further, the ROM 202 also stores a boot program, font data, and so forth. The RAM 203 is a main storage memory for the CPU 201 and is used as a work area. Further, the RAM 203 is used as a temporary storage area for loading the variety of control programs stored in the ROM 202 or the storage 204. In the storage 204, image data, print data, an address book, a variety of programs, account information, a variety of setting information, and so forth are saved. Further, in the storage 204, the agreement information notified from the device management server 102 via the communication section I/F 209 is also saved.

Note that although in the first embodiment, it is assumed that a flash memory is used as the storage 204, an auxiliary storage device, such as a solid state driver (SSD), a hard disk drive (HDD), and an embedded multi media card (eMMC), can be used. Further, although in the image forming apparatus 101, it is assumed that one CPU 201 executes processes, described hereinafter, by using one memory (RAM 203), this is not limitative. For example, a plurality of CPUs, RAMs, ROMs, and storages can operate in cooperation to execute the processes, described hereinafter. Further, part of the processes can be executed by a hardware circuit, such as an application specific integrated circuit (ASIC) or a field programmable gate array (FPGA).

The console section I/F 205 connects the controller 200 to the console section 210. The console section 210 includes a display section, such as a touch panel, and hard keys, displays information to a user, and detects an input from a user. The reading section I/F 206 connects the controller 200 to the reading section 211. The reading section 211 is e.g. a scanner and reads an image from an original. The image read by the reading section 211 is converted to image data, such as binary data, by the CPU 201. Further, the CPU 201 performs encryption processing and image processing on the image data converted to e.g. binary data according to settings of execution of reading. Thus, the image data generated by performing a variety of processing operations is transmitted to the device management server 102 or the like, or is printed on a recording sheet by the printing section 212, or is stored in an external storage device 213. Further, the reading section I/F 206 stores state information concerning the reading section 211, including a reading operation state, error information, and so forth, in the RAM 203 and notifies the same to the CPU 201.

The printing section I/F 207 connects the controller 200 to the printing section 212. The printing section 212 is e.g. a printer. The CPU 201 transfers image data to be printed (printing target image data) to the printing section 212 via the printing section I/F 207. The printing section 212 prints an image based on the transferred image data on a recording sheet fed from a sheet feed cassette (not shown). Further, the printing section I/F 207 stores state information concerning the printing section 212, including a print operation state, error information, and so forth, in the RAM 203, and notifies the same to the CPU 201.

The external storage I/F 208 connects the controller 200 to the external storage device 213. The CPU 201 stores the image data in the external storage device 213 via the external storage I/F 208. In the first embodiment, as the external storage I/F 208 and the external storage device 213, a universal serial bus (USB) interface and a USB memory are assumed. Note that an SD card or the like can be used as the external storage device 213. The communication section I/F 209 connects the controller 200 to the communication network 105. The communication section I/F 209 can transmit a variety of information in the image forming apparatus 101 to the device management server 102, the service management server 103, and the information processing apparatus 104.

The variety of information in the image forming apparatus 101 refer to a variety of setting information associated with the operation of the image forming apparatus 101 (such as printing and account control) and the use state information including the number of sheets printed by the image forming apparatus 101, error information, and so forth. Further, the communication section I/F 209 receives a request for referring to the variety of information in the image forming apparatus 101 and a request for changing the setting information from the device management server 102 and the information processing apparatus 104, reads out the variety of information from the storage 204, and changes the setting information. Note that transmission of the variety of information to the device management server 102 and the information processing apparatus 104 and reception of the agreement information and the request for changing the setting information from the device management server 102 and the information processing apparatus 104 are performed by a Web server application that processes the HTTP.

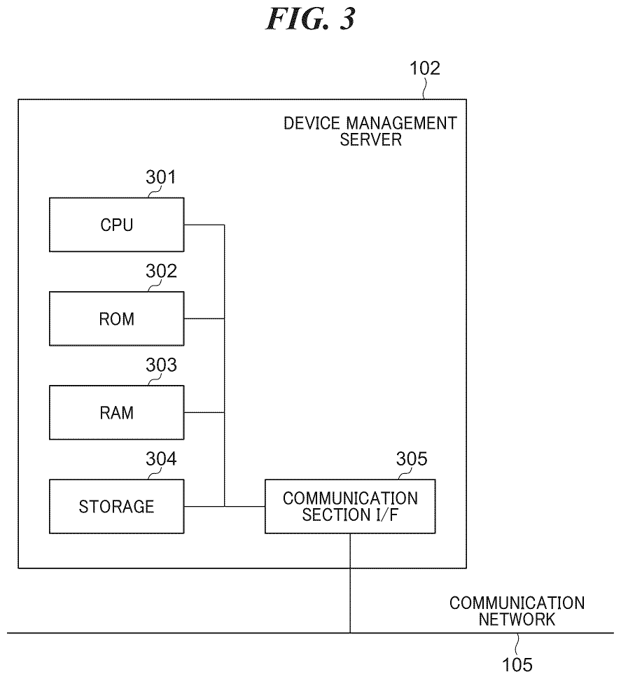

FIG. 3 is a diagram showing an example of a schematic hardware configuration of the device management server 102. The device management server 102 has a CPU 301, a ROM 302, a RAM 303, a storage 304, and a communication section I/F 305. The CPU 301 is a computer that performs processing, such as calculation of data and a command, determination, and control, according to control programs stored in the ROM 302 or the storage 304. The ROM 302 stores control programs and the like. The RAM 303 is used as a temporary storage area when the CPU 301 performs a variety of processing. In the storage 304, an operating system (OS), application software, the control programs, and so forth are stored. Further, the use state information of the image forming apparatus 101, described hereinafter, a variety of setting information (not shown), and the agreement information of the service agreement are also stored in the storage 304. The communication I/F 305 exchanges data with a device on the same network or the Internet according to a protocol, such as the TCP/IP, by using a wireless local area network (LAN) or wired LAN, conforming to the standard of IEEE 802.11a or the like.

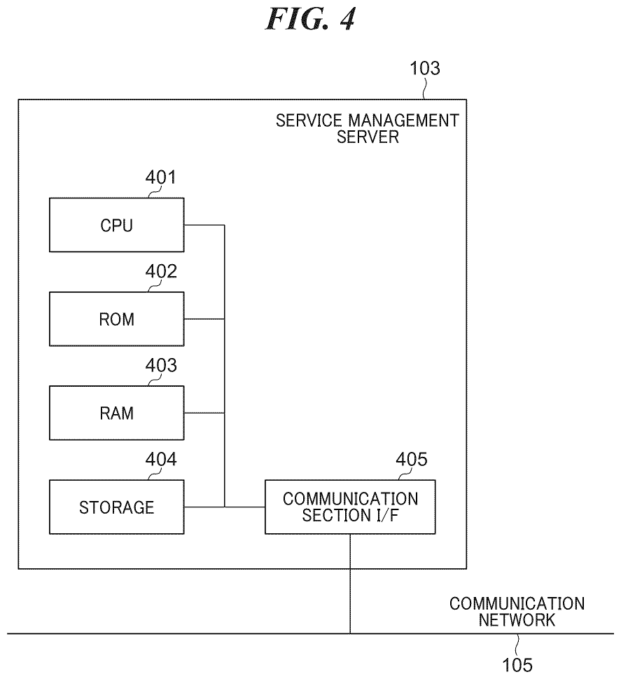

FIG. 4 is a diagram showing an example of a schematic hardware configuration of the service management server 103. The service management server 103 has a CPU 401, a ROM 402, a RAM 403, a storage 404, and a communication section I/F 405. The schematic hardware configuration of the service management server 103 is the same as the above-described schematic hardware configuration of the device management server 102. However, differently from the device management server 102, in the service management server 103, control for managing a variety of services operates. For example, if the service for which the service agreement is concluded by a user is a service for enabling the user to use an apparatus main body and consumables at a flat rate for a predetermined time period, the service management server 103 has a dashboard function for clearly displaying processing for automatically delivering an apparatus main body which has reached its end of life and consumables and the contents of the agreement. Other components are the same as the above-described schematic hardware configuration of the device management server 102, and hence detailed description thereof is omitted.

Note that the schematic hardware configurations shown in FIGS. 3 and 4 are not limited to the above-described configurations, but, for example, can be a configuration which realizes a service which the device management server 102 or the service management server 103 can provide by a server on a cloud. Further, the device management server 102 and the service management server 103 are not necessarily required to be configured as single servers, respectively. That is, the functions provided by the device management server 102 and the service management server 103 can be realized by a server system formed by a plurality of, i.e. three or more servers, or by an all-in-one server formed by integrating all the servers.

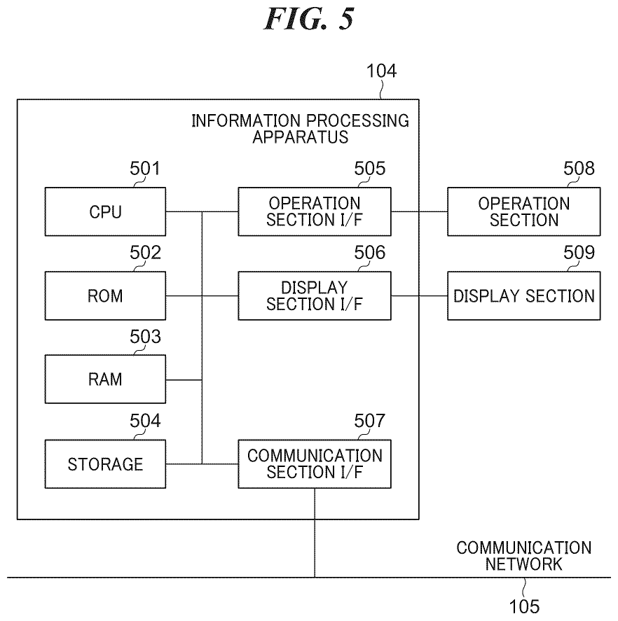

FIG. 5 is a diagram showing an example of a schematic hardware configuration of the information processing apparatus 104. The information processing apparatus 104 has a CPU 501, a ROM 502, a RAM 503, a storage 504, an operation section I/F 505, a display section I/F 506, and a communication section I/F 507. The CPU 501 is a computer that realizes functions which the information processing apparatus 104 has, by controlling the hardware components 502 to 507 forming the information processing apparatus 104. Note that the CPU 501 sends signals to the above-described hardware components 502 to 507 via a bus line, and further, realizes data communication with the other hardware.

Further, the CPU 501 controls the operation of the information processing apparatus 104 according to control programs stored in the ROM 502. More specifically, the CPU 501 executes an OS for controlling the information processing apparatus 104 and so forth. Then, the application programs interact with each other on the OS, whereby operations and control of functions desired by a user are performed. These programs including the OS are stored in the ROM 502, which are loaded into the RAM 503, and executed. The ROM 502 is a memory storing the control programs, a variety of data, and so forth, which are used by the CPU 501.

The RAM 503 is a work memory for temporarily storing program data used by the CPU 501 to perform calculation. The storage 504 is a storage device storing a variety of data, and a variety of programs. Note that in the first embodiment, an HDD is assumed as the storage 504, but another nonvolatile storage device, such as an SSD, can be the storage 504. The operation section I/F 505 connects the information processing apparatus 104 to an operation section 508. The operation section 508 is e.g. a keyboard and a mouse. The display section I/F 506 connects the information processing apparatus 104 to a display section 509. The display section 509 is e.g. a liquid crystal display.

The communication section I/F 507 is a network I/F for performing e.g. wired LAN communication. Note that the communication section I/F 507 can be a network I/F for performing wireless LAN communication or a USB I/F or the like. Further, in the first embodiment, the information processing apparatus 104 is assumed to be personal computer, and hence, the operation section 508 and the display section 509 are illustrated in a form not included in the information processing apparatus 104. However, in a case where the information processing apparatus 104 is a smartphone or the like, the operation section 508 and the display section 509 are included in the information processing apparatus 104, but the present disclosure can also be applied to this case.

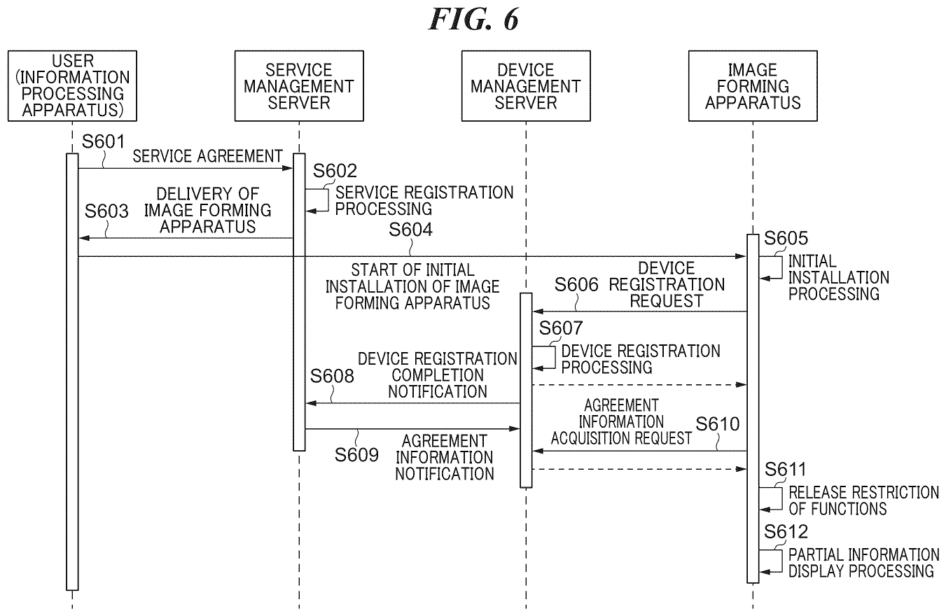

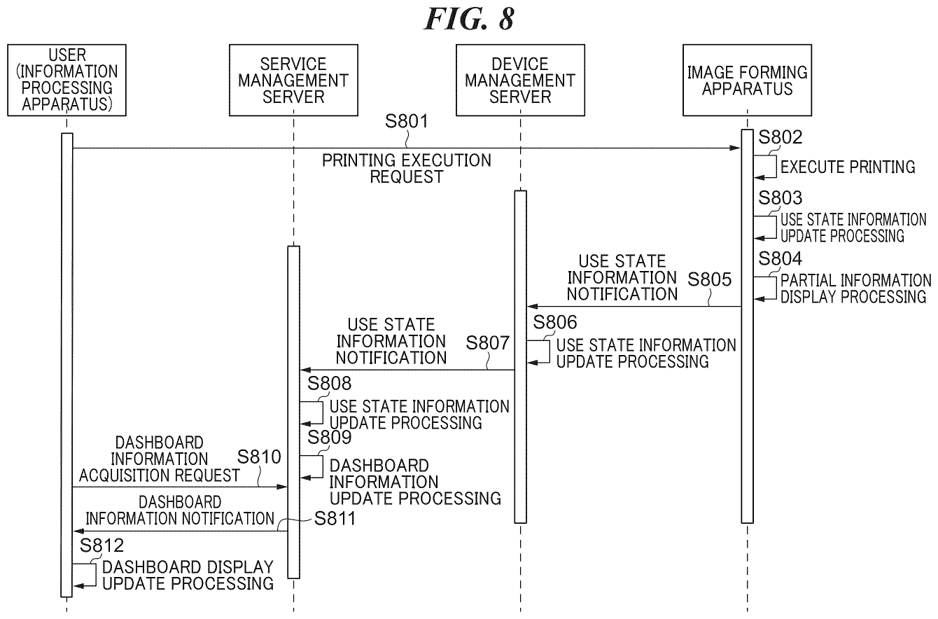

FIG. 6 is a sequence diagram showing a process in which after a user has concluded a service agreement, the service of this service agreement becomes available in the image forming apparatus 101, and further, it becomes possible to display part of agreement information and the like of this service agreement on the image forming apparatus 101. Steps of the image forming apparatus 101 in FIG. 6 are realized by the CPU 201 that loads a control program from the ROM 202 or the storage 204 into the RAM 203 and executes the loaded program. Steps of the device management server 102 in FIG. 6 are realized by the CPU 301 that loads a control program from the ROM 302 or the storage 304 into the RAM 303 and executes the loaded program. Steps of the service management server 103 in FIG. 6 are realized by the CPU 401 that loads a control program from the ROM 402 or the storage 404 into the RAM 403 and executes the loaded program. Steps of the information processing apparatus 104 in FIG. 6 are realized by the CPU 501 that loads a control program from the ROM 502 into the RAM 503 and executes the loaded program. Note that the above-mentioned points are also applied to the sequence diagrams in FIGS. 8, 12, 14, and 17, described hereinafter.

In the following description, a case where a user accesses a system that manages a service by using the information processing apparatus 104 and concludes a service agreement will be described by way of example. Let it be assumed that the service of the service agreement concluded by the user is a single service for enabling the user to use the main body of the image forming apparatus 101 and the consumables (such as a toner cartridge and a drum cartridge) attached to the image forming apparatus 101 for a predetermined period at a flat rate. That is, the service agreement concluded by the user is a subscription agreement of the image forming apparatus 101. Further, the consumables as the target of the service agreement are the toner cartridges and the drum cartridges but can be other components which can be replaced by the user, such as a cassette for feeding sheets and a fixing unit. Further, the user is not necessarily required to be only a person who uses the service but can be an operator who performs operations, such as initial installation and maintenance.

In a step S601, the user operates the information processing apparatus 104 to access the system that manages the service on the service management server 103, and concludes the service agreement on this system. In a step S602, in the service management server 103, upon receipt of conclusion of the service agreement, which is performed by the user, the CPU 401 performs service registration processing for associating user information with the image forming apparatus 101. Note that the user information includes agreement information of the service agreement concluded by the user (hereinafter simply also referred to as the “agreement information”). Further, the contents of the service registration processing are saved in the storage 404. In a step S603, when the service registration processing is completed by the service management server 103, the service provider delivers the image forming apparatus 101 registered in the step S602 to the user.

In a step S604, when the user receives the image forming apparatus 101, the user opens the package of the image forming apparatus 101 and further, starts initial installation of the image forming apparatus 101. In a step S605, in the image forming apparatus 101, the CPU 201 performs initial installation processing according to a user's instruction in the initial installation of the image forming apparatus 101. In the initial installation processing, the CPU 201 performs initial setting, such as network setting for connecting to the Internet. In a step S606, in the image forming apparatus 101, when network connection is completed in the initial setting, the CPU 201 communicates with the device management server 102 to request registration of the device. In this communication for the device registration request, the CPU 201 transmits identification information, such as a product serial number of the image forming apparatus 101, together with the device registration request. Note that the communication for the device registration request to the device management server 102 can be performed not from the image forming apparatus 101, but from the information processing apparatus 104, a smartphone, not shown, or the like.

In a step S607, in the device management server 102, upon receipt of the device registration request from the image forming apparatus 101, the CPU 301 performs device registration processing based on the identification information received from the image forming apparatus 101. Further, in the device management server 102, when the registration processing is completed, the CPU 301 transmits a result of the registration to the image forming apparatus 101 as a response. In a step S608, in the device management server 102, the CPU 301 transmits a device registration completion notification to the service management server 103. At this time, the CPU 301 transmits the identification information, such as the product serial number of the image forming apparatus 101, to the service management server 103 together with the device registration completion notification. Note that in a case where the service management server 103 is formed by a plurality of servers, this device registration completion notification can be transmitted to a server in charge, for each service.

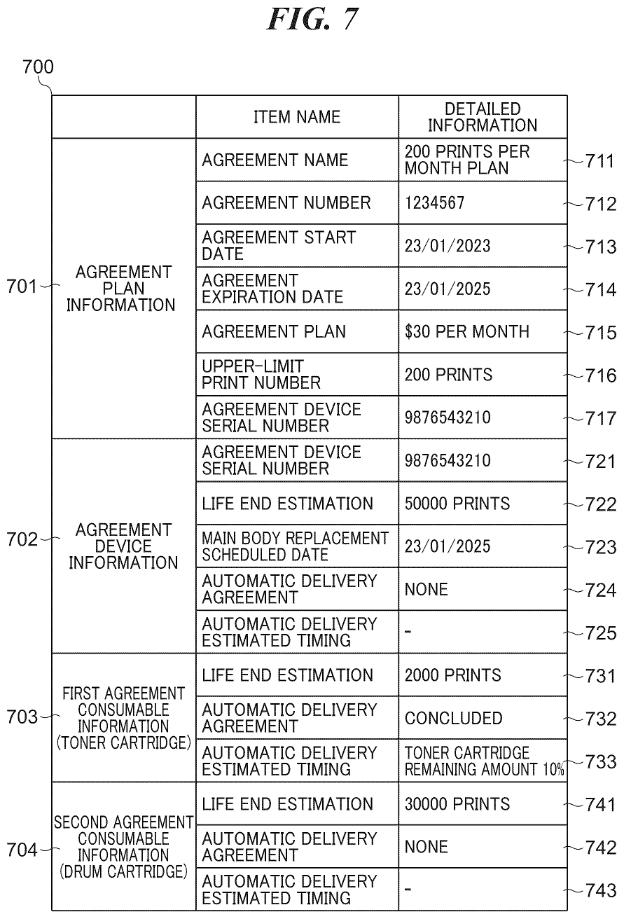

In a step S609, in the service management server 103, upon receipt of the device registration completion notification from the device management server 102, the CPU 401 transmits an agreement information notification to the device management server 102. In this agreement information notification, the CPU 401 notifies the device management server 102 of the agreement information (e.g. denoted by reference numeral 700 in FIG. 7, referred to hereinafter) associated with the image forming apparatus 101. In the first embodiment, the agreement information is information associated with the agreement, including information for determining that the agreement has been concluded, which is to be used for activation after the initial setting of the image forming apparatus 101. Details of the agreement information will be described hereinafter with reference to FIG. 7. Note that in the device management server 102, the CPU 301 stores the agreement information notified from the service management server 103 in the storage 304.

In a step S610, in the image forming apparatus 101, the CPU 201 communicates with the device management server 102 to request acquisition of the agreement information. Further, in the device management server 102, upon receipt of the agreement information acquisition request from the image forming apparatus 101, the CPU 301 (transmission unit) notifies the image forming apparatus 101 of the agreement information stored in the storage 304 as a HTTP response. Note that in the first embodiment, the agreement information of the service agreement is only one, but in a case where the user has concluded a plurality of service agreements, the agreement information of the plurality of service agreements can be collectively notified.

In a step S611, in the image forming apparatus 101, upon receipt of the agreement information from the device management server 102, the CPU 201 (reception unit) stores the received agreement information in the storage 204. Further, in the image forming apparatus 101, the CPU 201 reflects control associated with the received agreement information on the control of the image forming apparatus 101 thereafter. Specifically, for example, when it is confirmed that the service agreement has been concluded, the CPU 201 removes restriction thus far imposed on using the functions of the image forming apparatus 101, which are related to the service of the service agreement, and enables the user to use the functions. In the first embodiment, the image forming apparatus 101 is provided on condition that the user has concluded the service agreement. Therefore, until it is confirmed in the step S611 that the service agreement has been concluded, all basic functions of the image forming apparatus 101, such as the print function, the scan function, and the copy function, are restricted. So, after the step S611, these functions become available according to the agreement information of the service agreement of which conclusion has been confirmed.

In a step S612, in the image forming apparatus 101, the CPU 201 performs partial information display processing. In this partial information display processing, the CPU 201 displays part of the use state information and the agreement information on the console section 210. The same partial information display processing as this is performed in a step S804 in FIG. 8, described hereinafter. So, the partial information display processing will be described in detail in the step S804 described hereinafter with reference to FIG. 8.

FIG. 7 is a diagram showing an example of the agreement information of the service agreement. In the first embodiment, the agreement information 700 of the service agreement (hereinafter simply referred to as the “agreement information 700”) includes agreement plan information 701, agreement device information 702, first agreement consumable information 703, and second agreement consumable information 704. Note that the agreement information 700 can include any other information and include agreement consumable information other than the first and second agreement consumable information 703 and 704. Further, the agreement information 700 is information associated with the service agreement, and hence the agreement information 700 is updated when the user changes the service agreement, but can include information which changes insofar it is information associated with the service agreement, even when the user does not change the service agreement.

The agreement plan information 701 is information concerning the agreement plan of the service agreement concluded by the user. An agreement name 711 is information indicating the agreement name of the service agreement concluded by the user. An agreement number 712 is an ID issued when the service agreement is concluded and is information for uniquely identifying the service agreement. Further, the agreement number 712 is also information used by the CPU 201 of the image forming apparatus 101 so as to determine that the service agreement has been concluded in the step S611.

An agreement start date 713 is information indicating a start date of the agreement period of the service agreement concluded by the user. Note that the information indicated by the agreement start date 713 coincides with a use start date of the image forming apparatus 101. An agreement expiration date 714 is information indicating a scheduled date of the end of the agreement period of the service agreement, which date was agreed by the user when concluding the service agreement. Unless there is a midterm cancellation request or a request for updating the service agreement from the user, the date indicated by the agreement expiration date 714 is the expiration date of the agreement period of the service agreement. Note that in a case where the service agreement is updated, the agreement expiration date 714 is also updated together. An agreement plan 715 is information indicating a charge plan determined for each service agreement.

An upper-limit print number 716 is information indicating the upper limit number of prints, which is determined for each service agreement. Depending on a service agreement, for example, the upper limit number of prints for each month, such as 30 sheets/month, is determined. In a case where the number of printed sheets reaches the upper limit number, whether or not printing becomes incapable of being executed or whether printing becomes capable of being executed if a user pays a predetermined charge per one sheet is different for each service agreement. In the first embodiment, when the number of printed sheets reaches the upper limit number, printing becomes incapable of being inhibited. Note that in a case where a service agreement with no upper limit number of prints is concluded, any number of sheets can be printed per month.

An agreement device serial number 717 is a serial number of a device for which the service agreement effectively functions. In the first embodiment, the image forming apparatus 101 is a device supplied by the service provider. Therefore, the agreement device serial number 717 is information indicating the serial number of the image forming apparatus 101 delivered to the user by the service provider. Note that in a case where the user purchases the image forming apparatus 101 and concludes a service agreement for enabling the user to use only the consumables at a flat rate, the agreement device serial number 717 is information indicating the serial number of the image forming apparatus 101 registered by the user when the service agreement has been concluded.

The agreement device information 702 is information concerning the image forming apparatus 101 supplied from the service provider. Note that in the case where the user purchases the image forming apparatus 101 and concludes a service agreement for enabling the user to use only the consumables at a flat rate, the agreement device information 702 is not included in the agreement information 700. An agreement device serial number 721 is the same information as the agreement device serial number 717.

Life end estimation 722 is information indicating the number of sheets which can be printed by the image forming apparatus 101 with the print quality of a predetermined standard in a general use environment and use method, by the number of sheets specified by the maker of the image forming apparatus 101. Depending on a use environment, a use method, and an individual difference of the image forming apparatus 101, there is a case where the number of sheets not smaller than the number indicated by the life end estimation 722 can be printed, or the print quality can be lowered before the number of printed sheets reaches the number of sheets indicated by the life end estimation 722. Therefore, the life end estimation 722 is only information indicating a guideline value. A main body replacement scheduled date 723 is information indicating a scheduled date to replace the image forming apparatus 101 with a new one. In the first embodiment, the main body replacement scheduled date 723 is the same date as the agreement expiration date 714 but can be set to a date before the agreement expiration date 714, depending on an agreement plan of the service agreement.

An automatic delivery agreement 724 is information indicating whether or not a service agreement has been concluded for automatically delivering an apparatus main body when replacing the main body of the image forming apparatus 101. Whether or not to automatically deliver the apparatus main body can be selected by the user when the service agreement is concluded, and further, the selection can be changed if during the service agreement period. In a case where the apparatus main body is not automatically delivered, the user requests replacement of the apparatus main body to the service provider and replaces the apparatus main body on a convenient date designated by the user. Note that in the first embodiment, the automatic delivery agreement 724 is set to “not concluded”. When replacing the apparatus main body, a user's work, such as inheritance of the settings of the image forming apparatus 101, is needed, and it is necessary to secure a place where an apparatus main body automatically delivered is to be temporarily placed. Therefore, if the apparatus main body is automatically delivered at a timing not intended by the user, the user can be confused. It is assumed that the user who does not desire such a situation sets the automatic delivery agreement 724 to “not concluded”.

An automatic delivery estimated timing 725 is information indicating a condition for automatically delivering an apparatus main body in a case where the automatic delivery agreement 724 is set to “concluded”. In the first embodiment, the automatic delivery agreement 724 is set to “not concluded”, and hence the condition for automatically delivering the apparatus main body is set to “-”. The symbol “-” expresses no condition. Note that as the condition for automatically delivering the apparatus main body, for example, a condition that “when the number of printed sheets reaches xxxx”, “three days before the main body replacement scheduled date”, or the like can be set.

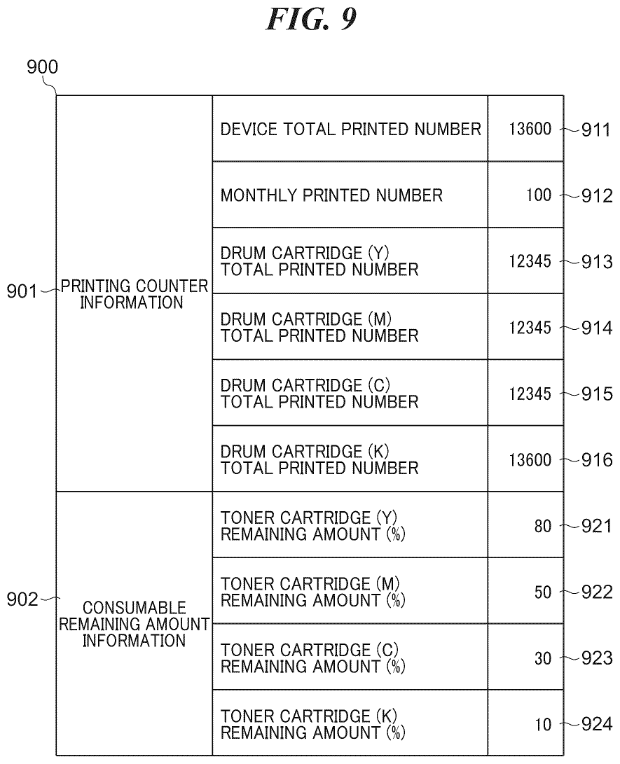

The first agreement consumable information 703 is information concerning a first consumable to be provided to the user according to the service agreement. In the first embodiment, the first agreement consumable information 703 is information concerning a toner cartridge. Life end estimation 731 is information indicating a guideline value of the life time associated with the toner cartridge. Detailed description of the life end estimation 731 is the same as the life end estimation 722, and hence the detailed description thereof is omitted. An automatic delivery agreement 732 is information indicating whether or not a service agreement for automatically delivering the first consumable has been concluded. In the first embodiment, the automatic delivery agreement 732 is set to “concluded”. An automatic delivery estimated timing 733 is information indicating a condition for automatically delivering the first consumable in a case where the automatic delivery agreement 732 is set to “concluded”. In the first embodiment, the automatic delivery estimated timing 733 is set to “toner cartridge remaining amount 10%”. Note that the information of the toner cartridge remaining amount is notified from the image forming apparatus 101 to the device management server 102 and the service management server 103 as the use state information (e.g. denoted by reference numeral 900 in FIG. 9, described hereinafter).

The second agreement consumable information 704 is information concerning a second consumable provided to the user in association with the service agreement. In the first embodiment, the second agreement consumable information 704 is information concerning a drum cartridge. Life end estimation 741 is information indicating a guideline value of the life time associated with the drum cartridge. The life end estimation 741 is similar to the life end estimation 722, and hence the detailed description thereof is omitted. An automatic delivery agreement 742 is information indicating whether or not a service agreement for automatically delivering the second consumable has been concluded. An automatic delivery estimated timing 743 is information indicating a condition for automatically delivering the second consumable in a case where the automatic delivery agreement 742 is set to “agreed”. The automatic delivery agreement 742 and the automatic delivery estimated timing 743 are similar to the automatic delivery agreement 724 and the automatic delivery estimated timing 725, and hence the detailed description thereof is omitted.

FIG. 8 is a sequence diagram in the first embodiment, which shows a process until the dashboard display is performed by the information processing apparatus 104 when printing is performed by the image forming apparatus 101 during the service agreement period. In a step S801, in the information processing apparatus 104, the user communicates with the image forming apparatus 101 to request execution of printing. Note that in the first embodiment, the printing execution request is input from the operation section 508 of the information processing apparatus 104, by way of example. However, the printing execution request in the step S801 is not limited to this, but all printing execution requests, such as a request for executing copying of an original, which are input on the console section 210 of the image forming apparatus 101, are included.

In a step S802, in the image forming apparatus 101, upon receipt of the printing execution request from the user, the CPU 201 executes, using the printing section 212, printing according to the print settings of a print job, which have been made when communication for the printing execution request has been performed in the step S801. In a step S803, when execution of the printing has been completed in the image forming apparatus 101, the CPU 201 performs use state information update processing. In this use state information update processing, the CPU 201 updates the use state information of the image forming apparatus 101, which changes whenever printing of one page is executed.

FIG. 9 is a diagram showing an example of the use state information. In the first embodiment, the use state information 900 is stored in the storage 204 and includes printing counter information 901 and consumable remaining amount information 902. Note that the use state information 900 can include any other information which can be acquired by the image forming apparatus 101. In the first embodiment, the printing counter information 901 includes a device total print number 911, a monthly print number 912, and total print numbers 913, 914, 915, and 916 of the drum cartridges of four colors. Further, the consumable remaining amount information 902 includes remaining amounts 921, 922, 923, and 924 of the toner cartridges of four colors.

Note that in the first embodiment, when color printing is performed, the image forming apparatus 101 uses all the drum cartridges and the toner cartridges of YMCK, and when monochrome printing is performed, the image forming apparatus 101 uses only the drum cartridge and the toner cartridge of K. Therefore, in the use state information 900, only the total print number 916 of the K drum cartridge is larger than the total print numbers 913, 914, and 915 of the drum cartridges of YMC, and coincides with the device total print number 911. Further, the monthly print number 912 is information indicating the number of sheets printed in this month. The value of the monthly print number 912 increases with the device total print number 911 and is reset to 0 for each month. In the first embodiment, as indicated by the agreement start date 713, the service agreement starts from January 23. Therefore, the value of the monthly print number 912 is accumulated from January 23 to February 22 and is reset to 0 on February 23. After that, the monthly print number 912 is subjected to the same processing every month.

The description refers again to FIG. 8. In the step S804, in the image forming apparatus 101, the CPU 201 performs the partial information display processing. In this partial information display processing, the CPU 201 displays part of the use state information 900 and the agreement information 700 on the console section 210 of the image forming apparatus 101 as required based on the use state information 900 updated in the step S803. At this time, to notify the user of the necessary information within a limited display area on the console section 210, the CPU 201 displays important information (such as the monthly print number 912) narrowed down from the use state information 900, on the console section 210.

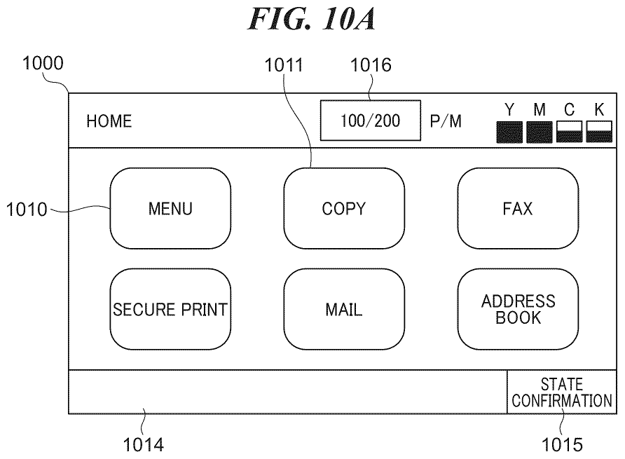

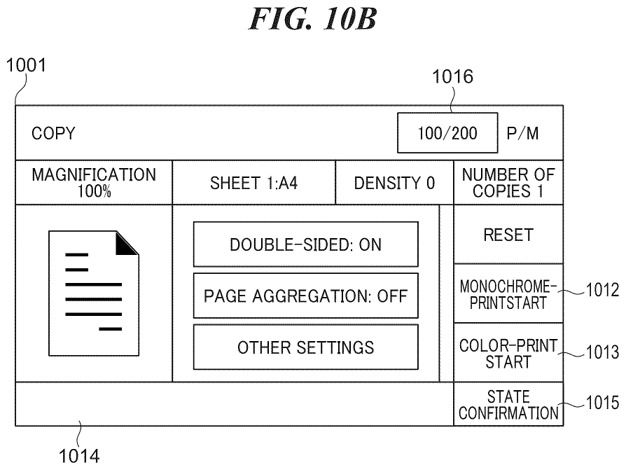

FIGS. 10A and 10B are diagrams each showing an example of partial display of the use state information 900 and the agreement information 700. FIGS. 10A and 10B are diagrams each showing an example of the console section 210 on which part of the use state information 900 and the agreement information 700 are displayed. FIG. 10A shows a home screen 1000. FIG. 10B shows a copy basic screen 1001. The home screen 1000 has buttons as entrances to a variety of functions, such as a menu button 1010 and a copy button 1011. When the copy button 1011 is pressed on the home screen 1000, the home screen 1000 shifts to the copy basic screen 1001 (transition screen). The copy basic screen 1001 has buttons for making a variety of settings for copying. These buttons include, for example, a monochrome-print start button 1012 and a color-print start button 1013.

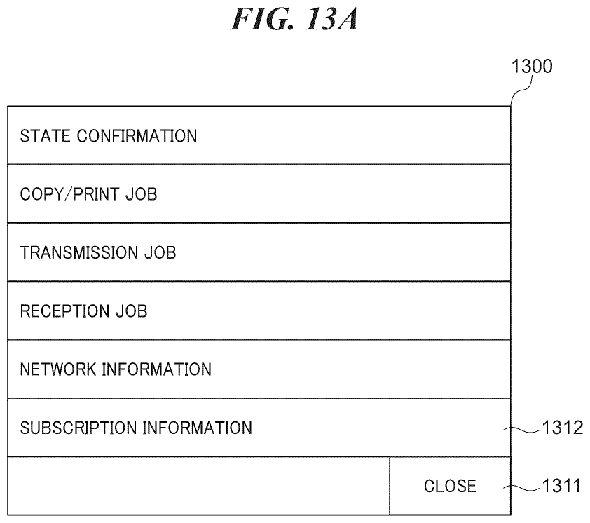

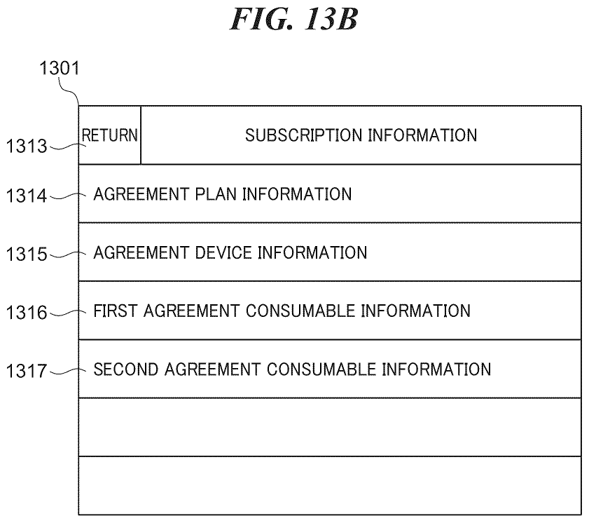

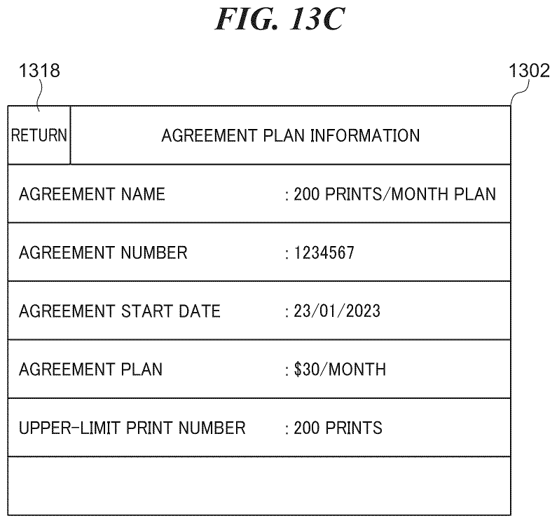

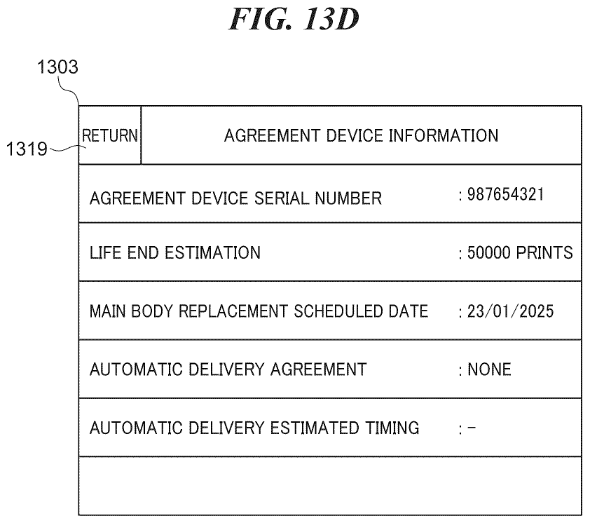

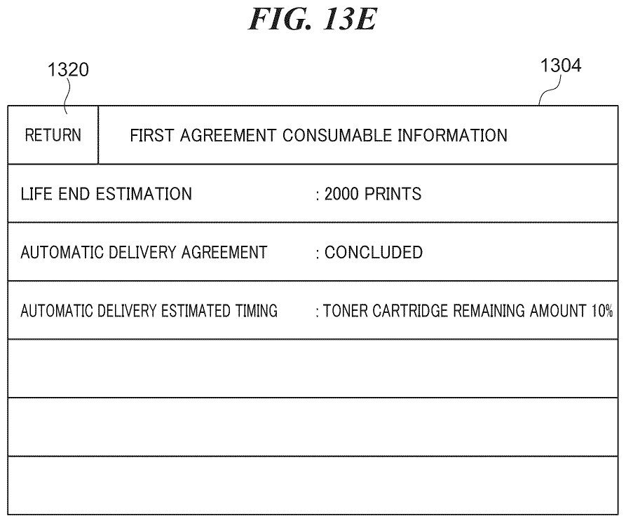

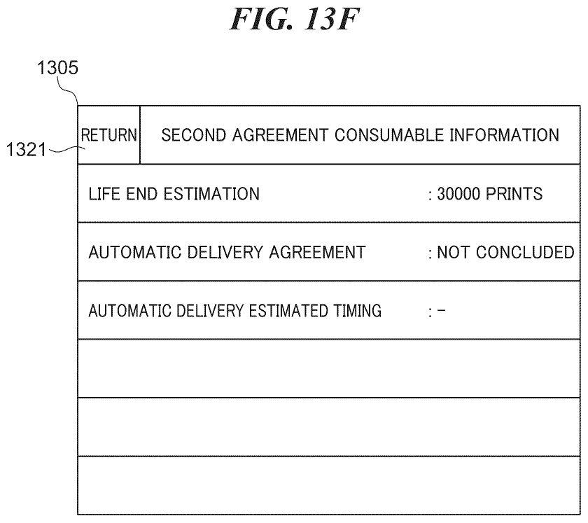

Further, the home screen 1000 and the copy basic screen 1001 both have a status line 1014, a state confirmation button 1015 for shifting to a state confirmation screen (e.g. denoted by reference numeral 1300, described hereinafter with reference to FIG. 13A), and a monthly printing state 1016. The status line 1014 is an area for displaying a message concerning a variety of warnings and an error. In the first embodiment, in the status line 1014, the information to be displayed is switched at fixed time intervals, whereby the display of a lot of warnings and an error is realized.

The monthly printing state 1016 has a numerator expressing the monthly print number 912 of the use state information 900 and a denominator expressing the upper-limit print number 716 of the agreement information 700 and displays the total print result of this month and the printing upper limit. In the first embodiment, the importance is placed on that, if the monthly print number 912 as the information concerning the number of printed sheets reaches the upper-limit print number 716 at a timing unexpected by the user, this causes a disadvantage to the user, and hence the monthly printing state 1016 is displayed on the console section 210 with the above-mentioned contents. Note that although in the first embodiment, as the example of the screen displaying part of the use state information 900 and the agreement information 700, the two screens of the home screen 1000 and the copy basic screen 1001 are described, the part of the use state information 900 and the agreement information 700 can be displayed on another suitable screen (transition screen).

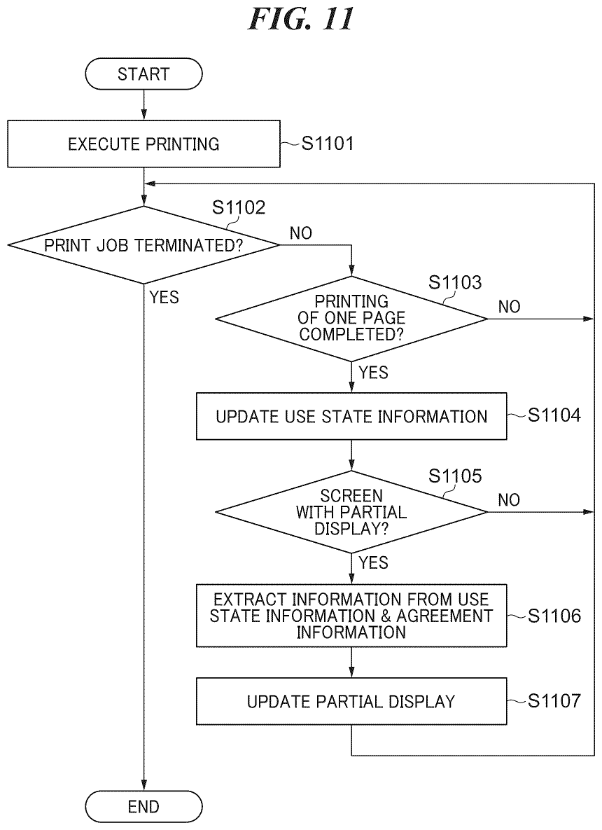

The description refers again to FIG. 8. Further, in the step S804, in the image forming apparatus 101, the CPU 201 updates the display of the monthly printing state 1016 based on the agreement information 700 stored in the storage 204 and the use state information 900 updated in the step S803. Note that although in the first embodiment, as the part of the use state information 900 and the agreement information 700, the monthly print number 912 and the upper-limit print number 716 are displayed in the form of a fraction, this is not limitative, but other information can be displayed. Further, all of the use state information 900 and the agreement information 700 can be displayed. Further, detailed description of the flow of the process performed by the image forming apparatus 101 in the steps S802 to S804 will be separately described hereinafter with reference to a flowchart in FIG. 11.

In a step S805, in the image forming apparatus 101, the CPU 201 notifies the device management server 102 of the use state information 900 whenever printing of one page, which is associated with the printing execution request in the step S801, is finished. In the first embodiment, the notification of the use state information 900 is provided for each page but can be provided at different intervals (such as every 5 pages). Further, the notification of the use state information 900 can be collectively provided after all printing is terminated, but in this case, if printing of 1000 pages is executed as one print job, the notification of the use state information 900 is provided after printing of 1000 pages is executed. This causes delay of arrangement of automatic delivery in the service management server 103 and detection of the life time of the apparatus main body and the consumables, and hence it is preferable that the notification of the use state information 900 is frequently provided.

In a step S806, in the device management server 102, the CPU 301 performs use state information update processing. In this use state information update processing, the CPU 301 updates the use state information 900 of the image forming apparatus 101, which is managed in the storage 304, based on the use state information 900 notified in the step S805. In a step S807, in the device management server 102, the CPU 301 notifies the service management server 103 of the use state information 900 updated in the step S806. In a step S808, in the service management server 103, the CPU 401 performs use state information update processing. In this use state information update processing, the CPU 401 updates the use state information 900 of the image forming apparatus 101, which is managed in the storage 404, based on the use state information 900 notified in the step S807.

In a step S809, in the service management server 103, the CPU 401 performs dashboard update processing. In this dashboard update processing, the CPU 401 updates the dashboard information with the use state information 900 updated in the step S808. The dashboard information refers to information in which information to be displayed on the dashboard is collected. In a step S810, in the information processing apparatus 104, the CPU 501 communicates with the service management server 103 to request acquisition of the dashboard information. This communication for the dashboard information acquisition request is performed when the user accesses the system that manages the service by using the information processing apparatus 104 at a desired timing to view the dashboard information.

In a step S811, in the service management server 103, upon receipt of the dashboard information acquisition request from the information processing apparatus 104, the CPU 401 notifies the information processing apparatus 104 of the dashboard information. In a step S812, in the information processing apparatus 104, the CPU 501 performs dashboard display update processing. In this dashboard display update processing, the CPU 501 displays the dashboard information on the display section 509 based on the dashboard information notified in the step S811. Note that how the dashboard information is specifically displayed on the display section 509 of the information processing apparatus 104 is not essential to the present disclosure, and hence detailed description thereof is omitted, and illustration thereof is not shown.

In the following description, the use state information update processing and the partial information display processing in the first embodiment will be described with reference to FIG. 11. FIG. 11 is a flowchart of a process from execution of printing to partial information display processing in the image forming apparatus 101 in the first embodiment. That is, the flowchart in FIG. 11 describes the processing operations from the step S802 to the step S804 in FIG. 8 in detail. Steps in FIG. 11 are realized by the CPU 201 (computer) that loads a control program (program) from the ROM 202 or the storage 204 into the RAM 203 and executes the loaded program in the image forming apparatus 101.

In a step S1101, the CPU 201 controls the printing section 212 to execute printing according to the print settings of the print job, which have been made when communication for the printing execution request has been performed in the step S801. In a step S1102, the CPU 201 determines whether or not the print job has been terminated e.g. by completion of printing of all pages or interruption due to an error. If it is determined by the CPU 201 that the print job has been terminated e.g. by completion of printing of all pages or interruption due to an error, the present process is terminated. On the other hand, if it is determined by the CPU 201 that the print job has not been terminated e.g. by completion of printing of all pages or interruption due to an error, the process proceeds to a step S1103.

In the step S1103, the CPU 201 determines whether or not printing of one page has been completed. If it is determined by the CPU 201 that printing of one page has not been completed, the process returns to the step S1102. On the other hand, if it is determined by the CPU 201 that printing of one page has been completed, the process proceeds to a step S1104. In the step S1104, the CPU 201 (update unit) updates the use state information 900. In this processing, the CPU 201 increments the values of the information belonging to the printing counter information 901 of the use state information 900 by one, on an as-needed basis. For example, in a case where black single color printing has been executed, the respective values of the device total print number 911, the monthly print number 912, and the total print number 916 of the drum cartridge (K) are incremented by one, respectively.

In a step S1105, the CPU 201 determines whether or not the screen which is currently displayed on the console section 210 is the screen which performs partial display of the use state information 900 and the agreement information 700. If it is determined by the CPU 201 that the screen which is currently displayed on the console section 210 is not the screen which performs the partial display of the use state information 900 and the agreement information 700, the process returns to the step S1102. On the other hand, if it is determined by the CPU 201 that the screen which is currently displayed on the console section 210 is the screen which performs the partial display of the use state information 900 and the agreement information 700, the process proceeds to a step S1106. Note that in the first embodiment, if the screen which is currently displayed on the console section 210 is the home screen 1000 or the copy basic screen 1001, it is determined that the screen which is currently displayed on the console section 210 is the screen which performs the partial display of the use state information 900 and the agreement information 700. On the other hand, if the screen which is currently displayed on the console section 210 is a screen other than the home screen 1000 or the copy basic screen 1001, it is determined that the screen which is currently displayed on the console section 210 is not the screen which performs the partial display of the use state information 900 and the agreement information 700.

In the step S1106, the CPU 201 (extraction unit) extracts information necessary for the partial display from the use state information 900 and the agreement information 700. In the first embodiment, the values (part of the information) of the monthly print number 912 and the upper-limit print number 716 are extracted from the use state information 900 and the agreement information 700 which are stored in the storage 204. In a step S1107, the CPU 201 (display unit) updates the partial display of the use state information 900 and the agreement information 700 which are displayed on the console section 210. At this time, the CPU 201 updates the partial display by replacing the values forming the monthly printing state 1016 with the values extracted in the step S1106. After that, the process returns to the step S1102.

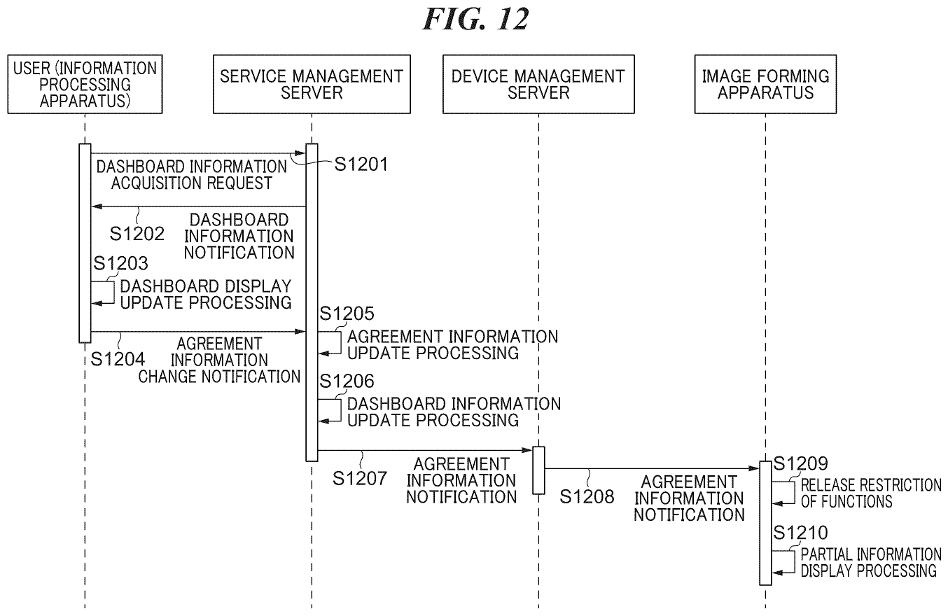

FIG. 12 is a sequence diagram associated with a change of the agreement information 700. In a step S1201, in the information processing apparatus 104, the user communicates with the service management server 103 to request acquisition of the dashboard information. In a step S1202, in the service management server 103, upon receipt of the dashboard information acquisition request from the user, the CPU 401 notifies the information processing apparatus 104 of the dashboard information. In a step S1203, in the information processing apparatus 104, the CPU 501 performs the dashboard display update processing. In the dashboard display update processing, the CPU 501 displays the dashboard information on the display section 509 based on the dashboard information notified in the step S1202.

In a step S1204, in the information processing apparatus 104, the user notifies the service management server 103 of a change of the agreement information 700 based on the dashboard information displayed on the display section 509. In the first embodiment, out of the agreement information 700, the agreement plan 715, and the agreement name 711 and the upper-limit print number 716, which are associated with the agreement plan 715, can be changed. In a step S1205, in the service management server 103, the CPU 401 performs agreement information update processing. In this agreement information update processing, the CPU 401 updates the agreement information 700 stored in the storage 304 based on the change of the agreement information 700, which is notified in the step S1204.

In a step S1206, in the service management server 103, the CPU 401 performs dashboard information update processing. In this dashboard information update processing, the CPU 401 updates the dashboard information based on the agreement information 700 updated in the step S1205. Similar to the step S609, in a step S1207, in the service management server 103, the CPU 401 notifies the device management server 102 of the agreement information 700. Note that in the device management server 102, the CPU 301 stores the agreement information 700 notified from the service management server 103 in the storage 304.

In a step S1208, in the device management server 102, the CPU 301 notifies the image forming apparatus 101 of the agreement information 700. Note that in the image forming apparatus 101, similar to the step S611, the CPU 201 stores the agreement information 700 in the storage 204. In steps S1209 and S1210, in the image forming apparatus 101, the CPU 201 performs processing for removing the restriction on the functions and the partial information display processing. The steps S1209 and S1210 are the same as the above-described steps S611 and S612, and hence detailed description thereof is omitted.

In the following description, the detailed display of the use state information 900 and the agreement information 700 in the first embodiment will be described with reference to FIGS. 13A to 13F. FIGS. 13A to 13F are diagrams each showing an example of a screen aimed to display further detailed information than the partial display of the use state information 900 and the agreement information 700, which is performed e.g. in the step S804. In the first embodiment, it is assumed that all of the agreement information 700 are displayed by the six screens shown in FIGS. 13A to 13F on the console section 210 of the image forming apparatus 101. The six screens shown in FIGS. 13A to 13F are the state confirmation screen 1300, a subscription information screen 1301, an agreement plan information screen 1302, an agreement device information screen 1303, a first agreement consumable information screen 1304, and a second agreement consumable information screen 1305. Note that in the first embodiment, the agreement information 700 is displayed on the console section 210 of the image forming apparatus 101, but a screen and information to be displayed can be increased or reduced, for example, such that the use state information 900 is included in the display.

The state confirmation screen 1300 shown in FIG. 13A is a screen playing the role of an entrance to display of a variety of screens associated with the states of the image forming apparatus 101. The state confirmation screen 1300 is a screen displayed when the user presses and selects (predetermined operation) the state confirmation button 1015 (predetermined button), which is included e.g. in the home screen 1000 and the copy basic screen 1001, shown in FIGS. 10A and 10B, respectively. Note that the state confirmation screen 1300 can be displayed when the user presses and selects (performs predetermined operation on) the display area (first display area) for displaying the monthly printing state 1016 e.g. on the home screen 1000 and the copy basic screen 1001 shown in FIGS. 10A and 10B. When the user presses a close button 1311, the state confirmation screen 1300 shifts to a preceding screen, such as the home screen 1000 or the copy basic screen 1001.

The subscription information screen 1301 shown in FIG. 13B is a screen displayed when the user presses a subscription information button 1312 included in the state confirmation screen 1300. When the user presses a return button 1313, the subscription information screen 1301 shifts to the state confirmation screen 1300. In the first embodiment, the user can view the information on the agreement information 700 by pressing buttons 1314 to 1317, referred to hereinafter, which are included in the subscription information screen 1301. That is, when, after pressing the above-mentioned state confirmation button 1015, the user presses any of the buttons 1314 to 1317, the CPU 201 (details display unit) of the image forming apparatus 101 displays an associated one of the screens 1302 to 1305, on which the information on the agreement information 700 is illustrated in detail, on the console section 210. Further, when the user presses any of the buttons 1314 to 1317, if it is possible to communicate with the device management server 102, the CPU 201 (second acquisition unit) of the image forming apparatus 101 attempts to acquire the agreement information 700.

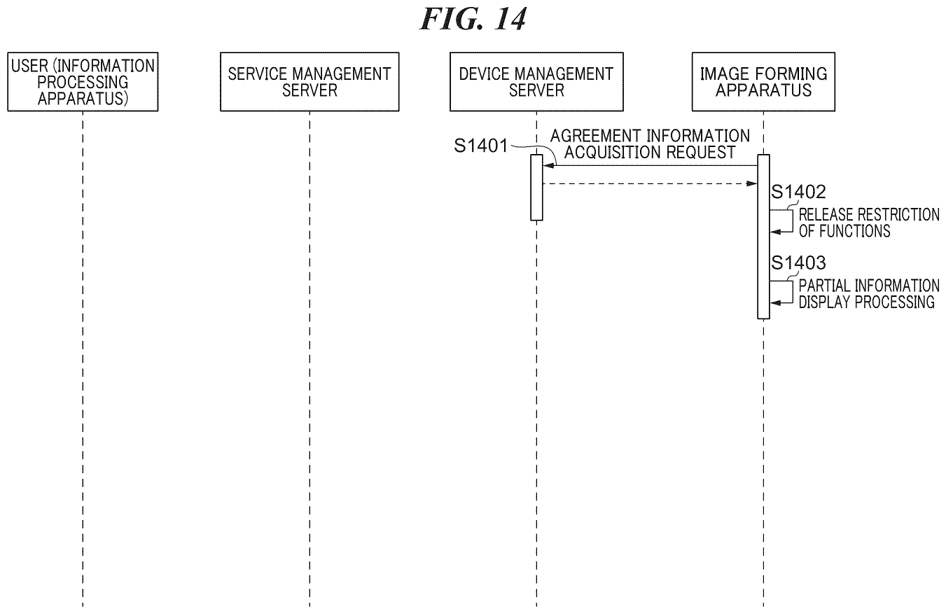

In the following description, acquisition of the agreement information 700 from the device management server 102 will be described with reference to FIG. 14. FIG. 14 is a sequence diagram associated with acquisition of the agreement information 700 from the device management server 102. In a step S1401, in the image forming apparatus 101, when any of the buttons 1314 to 1317 is pressed, the CPU 201 communicates with the device management server 102 to request acquisition of the agreement information. At this time, in the device management server 102, upon receipt of the agreement information acquisition request from the image forming apparatus 101, the CPU 301 notifies the image forming apparatus 101 of the agreement information 700 stored in the storage 304 as a HTTP response. Thus, the CPU 201 (second acquisition unit) of the image forming apparatus 101 acquires the latest agreement information from the device management server 102 when partial information display processing in a step S1403, described hereinafter, is performed.

Note that in the first embodiment, the information to be notified is assumed to be limited in accordance with a pressed button. For example, in a case where the agreement plan information button 1314 is pressed, the CPU 301 of the device management server 102 notifies the image forming apparatus 101 only of the agreement plan information 701 out of the agreement information 700. However, the CPU 301 of the device management server 102 can notify the image forming apparatus 101 of all of the agreement information 700 when any button is pressed. In the steps S1402 and S1403, in the image forming apparatus 101, the CPU 201 performs processing for removing the restriction on the functions and displaying the partial information. The steps S1402 and S1403 are the same as the above-described steps S611 and S612, and hence detailed description thereof is omitted.

The description refers again to FIG. 13. The agreement plan information screen 1302 shown in FIG. 13C is a screen displayed when the user presses the agreement plan information button 1314 included in the subscription information screen 1301. On the agreement plan information screen 1302, the agreement plan information 701 of the agreement information 700 is displayed. When the user presses a return button 1318, the agreement plan information screen 1302 shifts to the subscription information screen 1301. The agreement device information screen 1303 shown in FIG. 13D is a screen displayed when the user presses the agreement device information button 1315 included in the subscription information screen 1301. On the agreement device information screen 1303, the agreement device information 702 out of the agreement information 700 is displayed. When the user presses a return button 1319, the agreement device information screen 1303 shifts to the subscription information screen 1301. The first agreement consumable information screen 1304 shown in FIG. 13E is a screen displayed when the user presses the first agreement consumable information button 1316 included in the subscription information screen 1301. On the first agreement consumable information screen 1304, the first agreement consumable information 703 of the agreement information 700 is displayed. When the user presses a return button 1320, the first agreement consumable information screen 1304 shifts to the subscription information screen 1301. The second agreement consumable information screen 1305 shown in FIG. 13F is a screen displayed when the user presses the second agreement consumable information button 1317 included in the subscription information screen 1301. On the second agreement consumable information screen 1305, the second agreement consumable information 704 of the agreement information 700 is displayed. When the user presses a return button 1321, the second agreement consumable information screen 1305 shifts to the subscription information screen 1301.

As described above, the image forming apparatus 101 for which the subscription agreement has been concluded can prevent a user from suffering an unexpected disadvantage by displaying part of the use state information and the agreement information on the monthly printing state 1016 to enable the user to visually recognize the part of the information. Further, in the image forming apparatus 101, the monthly printing state 1016 for displaying the part of the use state information and the agreement information is displayed on the home screen 1000 and so forth, which facilitates the user to visually recognize the part of the use state information and the agreement information. Further, in the image forming apparatus 101, when the user presses e.g. the state confirmation button 1015, the user is enabled to view details of the agreement information e.g. on the agreement plan information screen 1302. With this, even in a situation where it is impossible to confirm the dashboard information being displayed on the information processing apparatus 104, the user can easily grasp the agreement information.

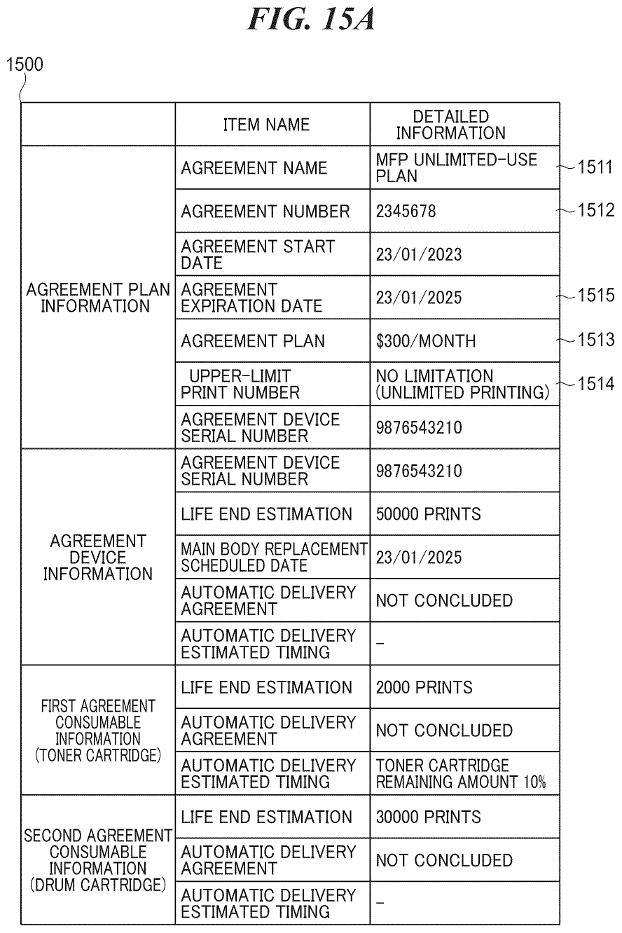

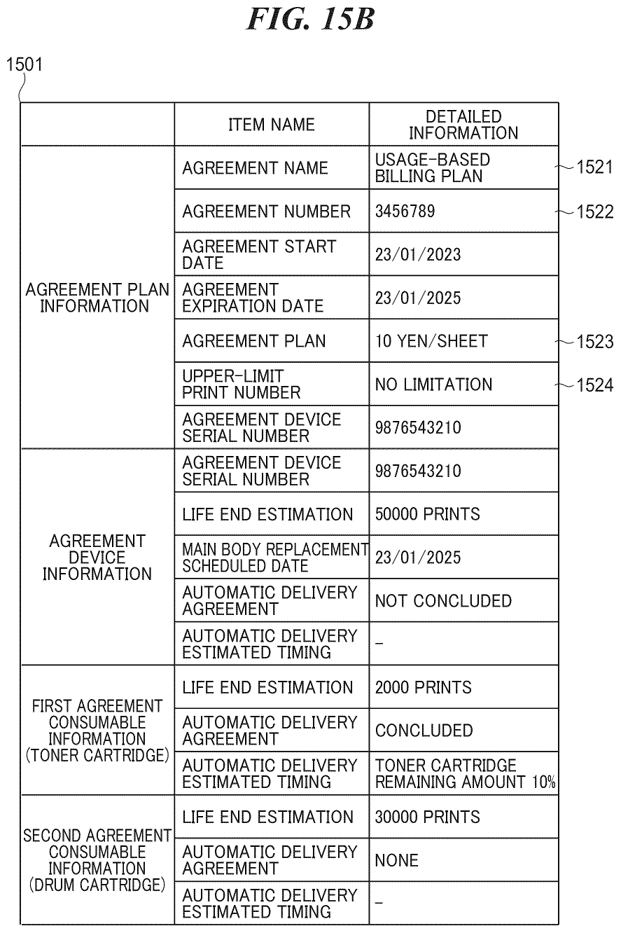

A second embodiment will be described below with reference to FIGS. 15A to 18B. In the second embodiment, the description will be given of a case where the user concludes a plurality of service agreements for the image forming apparatus 101, and the image forming apparatus 101 performs account management. Note that in the second embodiment, only differences from the first embodiment will be described. In the first embodiment, one service agreement has been concluded for one image forming apparatus 101, and the device management server 102 and the image forming apparatus 101 have received the agreement information 700 of this service agreement in the steps S609 and S611. Further, the image forming apparatus 101 does not perform the account management. On the other hand, in the second embodiment, three service agreements have been concluded for the image forming apparatus 101, and the image forming apparatus 101 receives the agreement information of each of the three service agreements and stores the received agreement information in the storage 204. Further, the image forming apparatus 101 performs the account management.

In the following description, an example of the agreement information in the second embodiment will be described with reference to FIGS. 15A and 15B. FIGS. 15A and 15B are diagrams each showing an example of agreement information of one of the plurality of service agreements. Agreement information 1500 of the service agreement, shown in FIG. 15A, and agreement information 1501 of the service agreement, shown in FIG. 15B, each have a plurality of items which are the same as those of the agreement information 700 shown in FIG. 7, but a value of each item is sometimes different. In this point, in the agreement information 1500 of the service agreement (hereinafter simply referred to as the “agreement information 1500”), values of an agreement name 1511, an agreement number 1512, an agreement plan 1513, and an upper-limit print number 1514 are different from the agreement information 700. Similarly, in the agreement information 1501 of the service agreement (hereinafter simply referred to as the “agreement information 1501”), values of an agreement name 1521, an agreement number 1522, an agreement plan 1523, and a upper-limit print number 1524 are different from the agreement information 700.

Note that the agreement names 1511 and 1521 and the upper-limit print numbers 1514 and 1524 are associated with the agreement plans 1513 and 1523, respectively. Further, the agreement information 1500 is a plan which allows printing without limitation and has the upper-limit print number 1514 set to no limitation (unlimited printing) and the agreement plan 1513 set to a flat rate per month. On the other hand, the agreement information 1501 is a usage-based billing plan and has the upper-limit print number 1524 set to no limitation but the agreement plan 1523 set to charging for each printed sheet. Note that although in the second embodiment, the agreement information 1501 as the usage-based billing plan charges for each printed sheet, a usage-based billing plan which is different from the agreement information 1501 can be employed, such as a plan which changes the charge for each sheet size. Further, compared with an illustrated example of the second embodiment, the number of the agreement information and items having different values can be different.

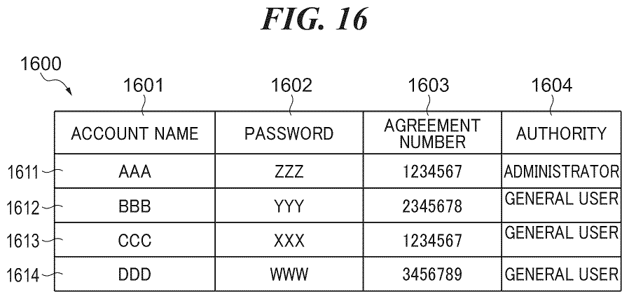

In the following description, the account management in the second embodiment will be described with reference to FIG. 16. FIG. 16 is a diagram showing an example of account information. The account information, denoted by reference numeral 1600, has an account name 1601, a password 1602, an agreement number 1603, and authority 1604. Further, in the illustrated example, the account information 1600 includes four accounts 1611 to 1614. The account name 1601 and the password 1602 are used when the user logs into the image forming apparatus 101. The agreement number 1603 indicates the agreement information associated with each of the accounts 1611 to 1614. The authority 1604 indicates a type of authority of each of the accounts 1611 to 1614. Note that in the second embodiment, it is assumed that the accounts 1611 and 1613 are associated with the agreement information 700, the account 1612 is associated with the agreement information 1500, and the account 1614 is associated with the agreement information 1501.

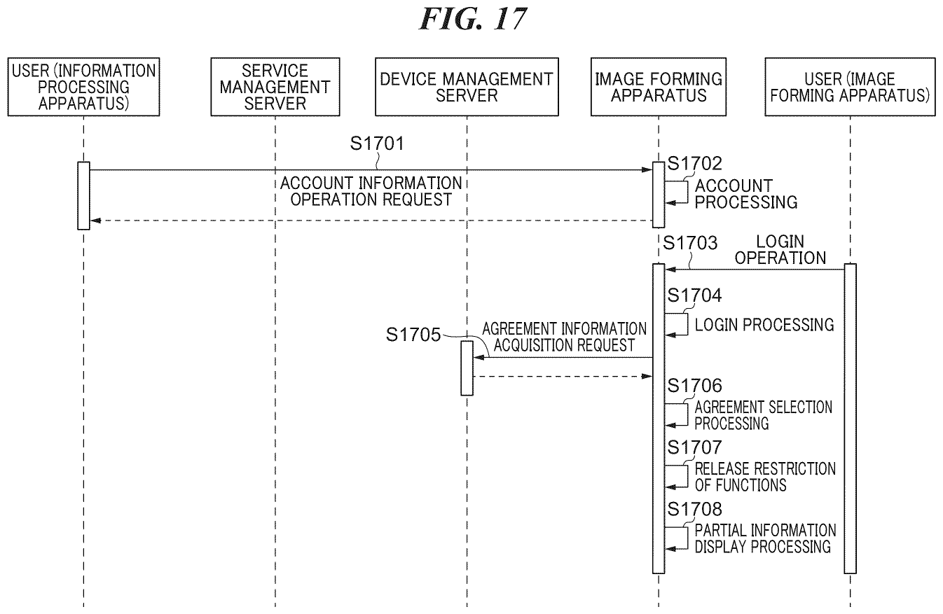

FIG. 17 is a sequence diagram of a process from an account information operation request to the partial information display processing. In a step S1701, in the information processing apparatus 104, the user communicates with the Web server application included in the image forming apparatus 101, to request an operation on the account information 1600. In a step S1702, in the image forming apparatus 101, the CPU 201 operates the account information 1600 stored in the storage 204 in response to the operation request received by the Web server application. Note that in the image forming apparatus 101, if the account has already been registered, and it is unnecessary to change the account, the steps S1701 and S1702 can be omitted. In the second embodiment, it is assumed that the four accounts 1611 to 1614 shown in FIG. 16 have already been registered in the image forming apparatus 101. In a step S1703, in the image forming apparatus 101, the user performs a login operation from the console section 210.

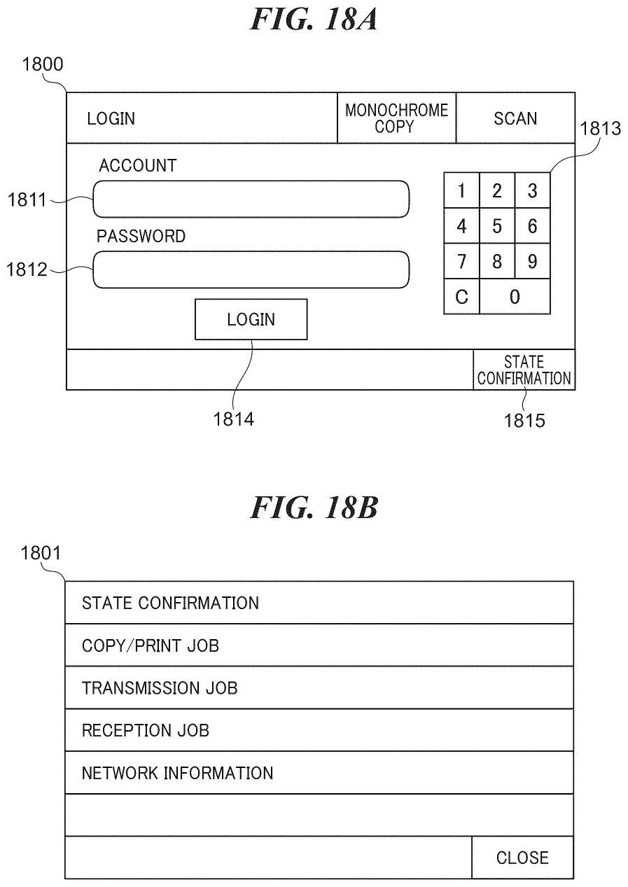

In the following description, the login operation in the step S1703 will be described with reference to FIGS. 18A and 18B. FIGS. 18A and 18B are diagrams showing respective examples of a login screen and a state confirmation screen. The login screen, denoted by 1800 in FIG. 18A and the state confirmation screen, denoted by 1801 in FIG. 18B are displayed on the console section 210 of the image forming apparatus 101. The login screen 1800 has an account input field 1811, a password input field 1812, an input section 1813, a login button 1814, and a state confirmation button 1815. The user can input the account name and the password by operating the input section 1813 in a state in which the account input field 1811 or the password input field 1812 is selected.

Further, when the user presses the login button 1814 after inputting the account name and the password, the login processing in a step S1704, described hereinafter, is started. Further, when the user presses the state confirmation button 1815, the login screen 1800 shifts to the state confirmation screen 1801. The state confirmation screen 1801 is almost the same as the above-described state confirmation screen 1300. However, in the second embodiment, the agreement information is associated with the account, and hence there is no agreement information to be displayed on the state confirmation screen 1801 before login. Therefore, on the state confirmation screen 1801, there is no button corresponding to the above-mentioned subscription information button 1312.

Referring again to FIG. 17, in the step S1704, when the user presses the login button 1814 in the image forming apparatus 101, the CPU 201 (login unit) performs the login processing. In the login processing, the CPU 201 collates the account information 1600 stored in the storage 204 with the contents input in the account input field 1811 and the password input field 1812. If there is an account from which a collation result indicating that both the information matches is obtained, the CPU 201 determines the account as the login account and determines that the login is successful. If there is no account from which a collation result indicating that both information matches is obtained, the CPU 201 determines that the login has failed. If the login is successful, the process proceeds to a step S1705, whereas if the login has failed, the process returns to the step S1703.

In the step S1705, in the image forming apparatus 101, the CPU 201 communicates with the device management server 102 to request acquisition of the agreement information. In the second embodiment, the agreement information of the service agreement includes the three items, i.e. the agreement information 700, the agreement information 1500, and the agreement information 1501. Therefore, in the device management server 102, upon receipt of the agreement information acquisition request from the image forming apparatus 101, the CPU 301 notifies the image forming apparatus 101 of the agreement information 700, 1500, and 1501, stored in the storage 304, as a HTTP response.

In a step S1706, in the image forming apparatus 101, upon receipt of the three agreement information 700, 1500, and 1501 from the device management server 102, the CPU 201 (first acquisition unit) performs agreement selection processing. In this agreement selection processing, the CPU 201 collates the agreement number, which the login account determined in the step S1704 has, with each of the agreement numbers of the received three agreement information items 700, 1500, and 1501. Further, the CPU 201 selects, out of the agreement information 700, 1500, and 1501, agreement information which matches in agreement number, as the agreement information for the login account. Then, the CPU 201 displays the home screen 1000 on the console section 210.

Note that when the user logs into the image forming apparatus 101 with the account 1611 or 1613, the agreement information 700 is selected as the agreement information for the login account, when the user logs into the image forming apparatus 101 with the account 1612, the agreement information 1500 is selected as the agreement information for the login account, and when the user logs into the image forming apparatus 101 with the account 1614, the agreement information 1501 is selected as the agreement information for the login account. In steps S1707 and S1708, the CPU 201 of the image forming apparatus 101 performs processing for removing the restriction on the functions and the partial information display processing. The steps S1707 and S1708 are the same as the above-described steps S611 and S612 except that the agreement information selected in the step S1706 is used, and hence detailed description thereof is omitted.

As described above, the image forming apparatus 101 for which the subscription agreement has been concluded displays part of the use state information and the agreement information associated with the login account on the monthly printing state 1016 to enable the user to visually recognize the displayed information. Thus, the image forming apparatus 101 enables the user to visually recognize the monthly printing state 1016 associated with the account of the user, and hence it is possible to prevent the user from suffering an unexpected disadvantage. Further, even in a case where the service agreement is different for each account, the image forming apparatus 101 can properly display the monthly printing state 1016 by selecting the agreement information associated with each login account.

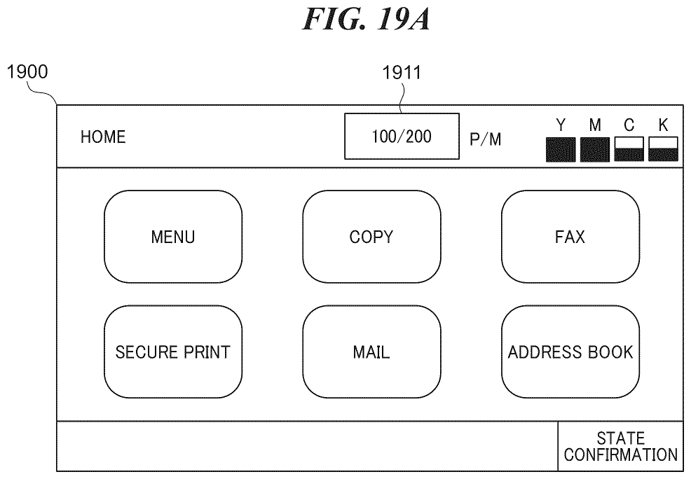

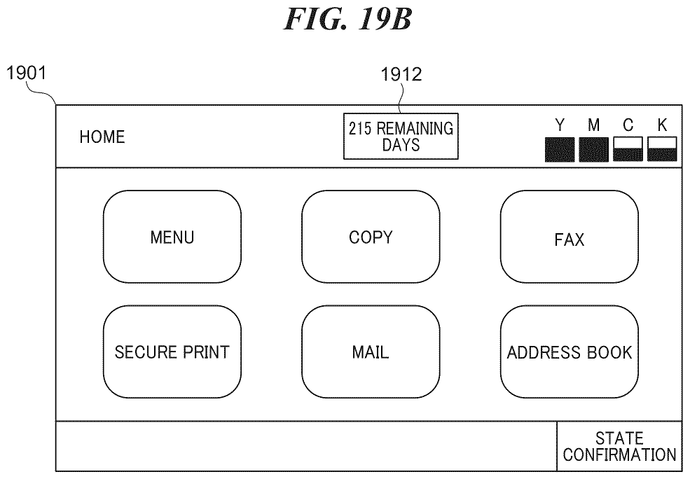

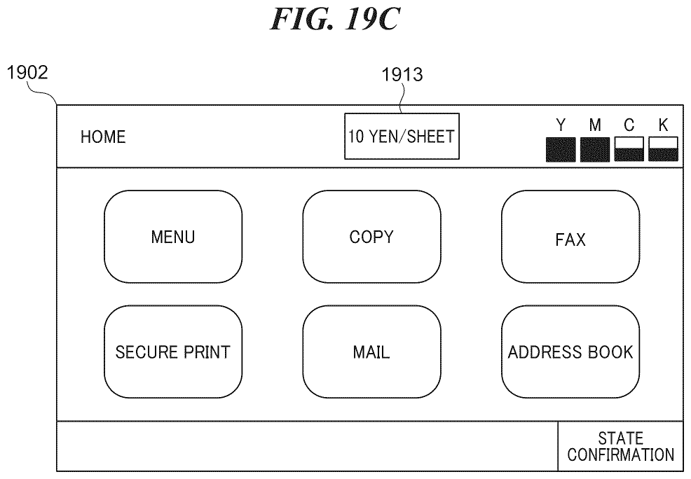

A third embodiment will be described below with reference to FIGS. 19A to 21. In the third embodiment, the description will be given of the information display corresponding to the agreement information associated with an account which has logged in the image forming apparatus 101. Note that in the third embodiment, only differences from the second embodiment will be described. In the third embodiment, the information corresponding to the agreement information associated with an account with which a user has logged in the image forming apparatus 101 is displayed on the console section 210.

In the following description, the partial display of the use state information 900 and the agreement information 700, 1500, or 1501 in the third embodiment will be described with reference to FIGS. 19A to 19C. FIGS. 19A to 19C are diagrams showing examples of the partial display of the use state information 900 and the agreement information 700, 1500, and 1501, respectively. In the third embodiment, one of a home screen 1900 shown in FIG. 19A, a home screen 1901 shown in FIG. 19B, and a home screen 1902 shown in FIG. 19C is displayed on the console section 210 of the image forming apparatus 101. The home screen 1900 shown in FIG. 19A includes a monthly printing state 1911. The monthly printing state 1911 is the same as the above-mentioned monthly printing state 1016. The home screen 1901 shown in FIG. 19B includes the number of agreement remaining days 1912. The number of agreement remaining days 1912 displays the number of days from the current date to the agreement expiration date. The home screen 1902 shown in FIG. 19C includes a usage-based charging price 1913. The usage-based charging price 1913 displays a value of a usage-based charge of the agreement plan (e.g. the agreement plan 1523 of the agreement information 1501) in a case where the service agreement is a usage-based charging agreement.

Note that in the second embodiment, the home screen 1000 is displayed on the console section 210 in the agreement selection processing in the step S1706. In this point, in the third embodiment, the home screen to be displayed on the console section 210 is changed according to the agreement information associated with the login account determined in the step S1704. Specifically, in the case of the agreement information 700 (monthly limited printing), the home screen 1900 with an upper limitation is displayed, in the case of the agreement information 1500 (unlimited printing), the home screen 1901 without limitation is displayed, and in the case of the agreement information 1501 (usage-based charging), the home screen 1902 of the usage-based charging is displayed.

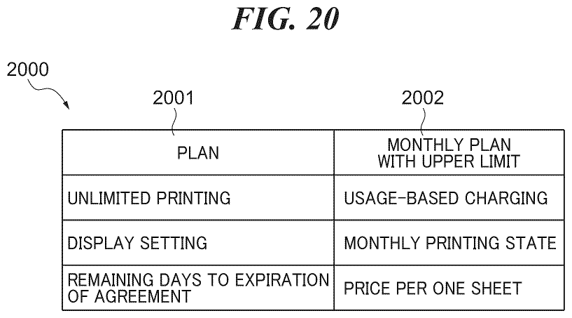

The association setting between the agreement information and the display information is managed by agreement-associated display setting 2000 shown in FIG. 20. The agreement-associated display setting 2000 includes a plan 2001 and a display setting 2002, and sets information to be displayed on the home screen for each agreement plan included in the agreement information. The agreement-associated display setting 2000 is stored in the storage 204. The user can change the setting of the agreement-associated display setting 2000 from the console section 210 of the image forming apparatus 101. Note that the display can be switched based on the agreement-associated display setting 2000 not only from the home screen, but also from all screens, such as the copy basic screen, on which partial display of the use state information and the agreement information is performed. Further, in the third embodiment, the information displayed on the console section 210 is separated according to the agreement plans of the monthly limited printing plan/the unlimited printing plan/the usage-based billing plan but can be separated according to another standard. Further, the information displayed e.g. on the home screen can be changed.

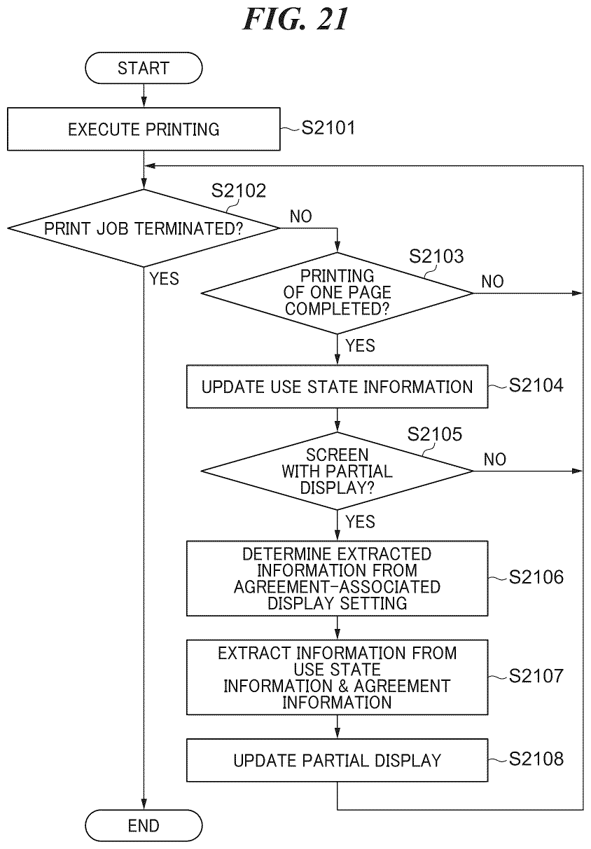

Further, in the second embodiment, the update of the use state information and the partial display is realized by the process shown in FIG. 11. In the third embodiment, the display information is changed according to the agreement-associated display setting 2000, and hence the process for the update in the third embodiment is partially different from the process in FIG. 11. So, the update of the use state information and the partial display in the third embodiment will be described with reference to FIG. 21. FIG. 21 is a flowchart of the process from execution of printing to partial information display processing. That is, the flowchart in FIG. 21 is the detailed description of the processing operations from the step S802 to the step S804 in FIG. 8. Steps in FIG. 21 are realized by the CPU 201 that loads a control program from the ROM 202 or the storage 204 into the RAM 203 and executes the loaded program in the image forming apparatus 101.

Steps S2101 to S2105 are the same as the above-described steps S1101 to S1105, and hence detailed description thereof is omitted. If the answer to the question of the step S2105 is affirmative (YES), in a step S2106, the CPU 201, determines extracted information by referring to the agreement-associated display setting 2000 stored in the storage 204. Specifically, in the case of the agreement information 700 (monthly limited printing), the monthly print number 912 and the upper-limit print number 716 are determined as the extracted information, and in the case of the agreement information 1500 (unlimited printing), an agreement expiration date 1515 is determined as the extracted information. Further, in the case of the agreement information 1501 (usage-based charging), the agreement plan 1523 is determined as the extracted information. In a step S2107, the CPU 201 extracts the information necessary for the partial display from the use state information 900 and the three agreement information 700, 1500, or 1501. In the third embodiment, the information determined as the extracted information in the step S2106 is extracted.

In a step S2108, the CPU 201 updates the partial display of the use state information 900 and the agreement information 700, 1500, or 1501, displayed on the console section 210. At this time, in the case of the agreement information 700 (monthly limited printing), the CPU 201 updates the partial display by replacing values forming the monthly printing state 1911 with the values of the information extracted in the step S2107. Further, in the case of the agreement information 1500 (unlimited printing), the CPU 201 updates the partial display by replacing the value forming the number of agreement remaining days 1912 with the number of days from the current date to the agreement expiration date as the value of the information extracted in the step S2107. Further, in the case of the agreement information 1501 (usage-based charging), the CPU 201 updates the partial display by replacing the value of the usage-based charging price 1913 with the information extracted in the step S2107. After that, the process returns to the step S2102.

As described above, the image forming apparatus 101 displays the monthly printing state 1911, the number of agreement remaining days 1912, or the usage-based charging price 1913 as part of the use state information and the agreement information according to the display setting 2002 set to each agreement plan of the service agreement. Thus, the image forming apparatus 101 can prevent the user from suffering an unexpected disadvantage by displaying part of the use state information and the agreement information according to the agreement plan of the service agreement. With this, even in a case where the service agreement is different for each account as in the second and third embodiments, the image forming apparatus 101 can properly display the part of the use state information and the agreement information.

The present disclosure has been described heretofore based on the embodiments thereof. However, the present disclosure is not limited to these embodiments, but it is to be understood that the disclosure includes various forms within the scope of the gist of the present disclosure. For example, the monthly print number 912 can be managed in a predetermined time period which is different from a month or can be managed at a location (such as the agreement information) other than the use state information 900.

Further, in the second and third embodiments, the partial display and the detailed display (hereinafter referred to as the “partial/detailed display”) of the use state information and the agreement information are performed based on the agreement information associated with the account with which the user has logged in. However, the partial/detailed display can be controlled such that the partial/detailed display is performed only in a case where the user has logged in with an account satisfying a specific condition but is not performed in a case where the user has logged in with another account. For example, the partial/detailed display can be controlled such that the partial/detailed display is performed only in a case where the user has logged in with the administrator account 1611 (predetermined account) but is not performed in a case where the user has logged in with another account. Thus, in the case where the information presented to the user is restricted according to the authority of each associated one of the accounts 1611 to 1614, it is also possible to realize the present disclosure.

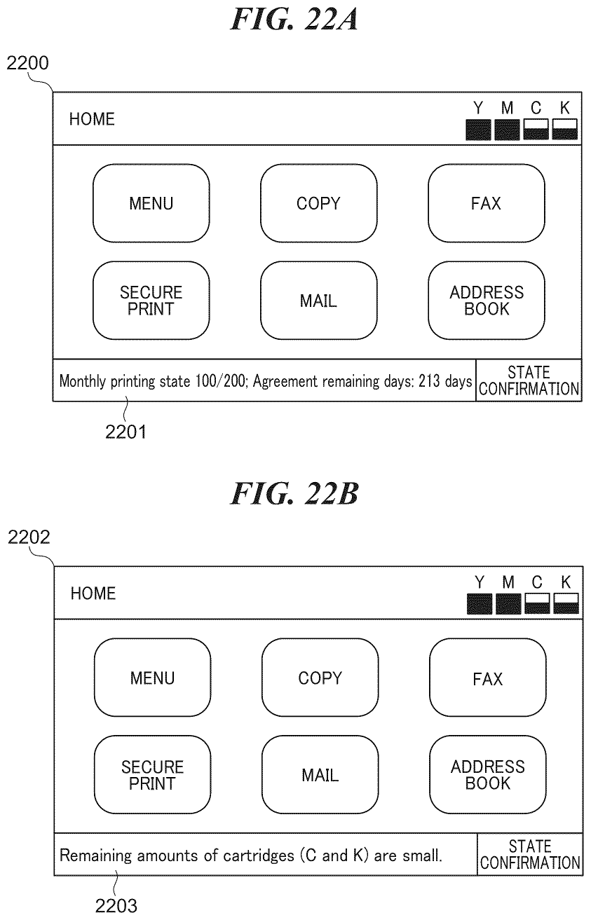

Further, on the status line 1014 (second display area) e.g. on the home screen 1000, part of the use state information and the agreement information can be displayed while being switched to the other warning or error information (other information) on an as-needed basis. In this case, e.g. on the home screen 1000, the display area is increased for part of the use state information and the agreement information, and further detailed information can be notified. FIGS. 22A and 22B are diagrams each showing an example of a screen displayed in a case where part of the use state information and the agreement information is displayed on the status line. A home screen 2200 shown in FIG. 22A includes a status line 2201. The CPU 201 of the image forming apparatus 101 displays part of the use state information and the agreement information on the status line 2201. Note that the CPU 201 of the image forming apparatus 101 can change the information to be displayed on the status line 2201 according to a variety of conditions, such as an agreement plan and authority, as described in the embodiments.

A home screen 2202 shown in FIG. 22B includes a status line 2203. In FIG. 22B, not part of the use state information and the agreement information, but another warning is displayed on the status line 2203. Therefore, on the status line 2203 (second display area), part of the use state information and the agreement information is not always displayed but displayed while being switched to another warning or error information (other information), on an as-needed basis, and hence the recognizability of the user is lowered. However, the display area on the console section 210 is more increased with respect to the part of the use state information and the agreement information, and the information which can be displayed is increased, which improves the visibility of the user.

Further, the CPU 201 of the image forming apparatus 101 can display part of the use state information and the agreement information only when a partial display condition is satisfied. As the partial display condition, the partial display can be performed when the number of remaining days to the agreement expiration date becomes smaller than a predetermined value, or when the monthly print number exceeds a predetermined value. With this partial display condition, it is possible to avoid a situation in which the display on the console section 210 in the image forming apparatus 101 is always occupied by the partial display of the use state information and the agreement information.

Further, in the second embodiment, the CPU 201 of the image forming apparatus 101 can display part of the use state information and the agreement information on the login screen 1800 (transition screen), or further detailed information can be displayed from the state confirmation screen 1801. Further, the information depending on a device, such as an agreement device serial number, is common without depending on an account used for login. Then, the CPU 201 (common display unit) of the image forming apparatus 101 can provide convenience to the user, by displaying, on the screens shown in FIGS. 10 and 13, the information common to a plurality of agreement information without depending on a login account.

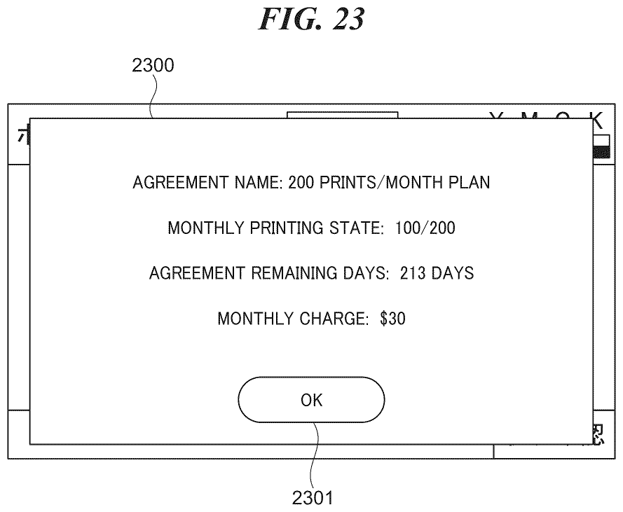

Further, part of the use state information and the agreement information can be displayed as a popup in a case where a popup condition, such as a timing at which login processing is performed, is satisfied by the image forming apparatus 101. For example, in the sequence shown in FIG. 17, when the processing in the step S1708 is terminated, the CPU 201 of the image forming apparatus 101 displays a popup screen on the console section 210. FIG. 23 is a diagram showing an example of the popup screen. On the popup screen, denoted by reference numeral 2300, part of the use state information and the agreement information based on a login account is displayed. Then, when the user presses an OK button 2301 on the popup screen 2300, the popup screen 2300 is closed, and the popup display is terminated. With this, the user can grasp the state of the image forming apparatus 101 when starting the operation of the image forming apparatus 101. Note that the popup condition is not limited to the above-mentioned timing of login processing, but for example, the popup display can be performed when the image forming apparatus 101 is powered on or when the image forming apparatus 101 is returned from a sleep state.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-064025 filed Apr. 11, 2024, which is hereby incorporated by reference herein in its entirety.

What is claimed is:

1. An image forming apparatus that acquires agreement information managed by a server and receives provision of a service according to the agreement information, comprising:
at least one memory storing a program; and
at least one processor that executes the stored program, which cause the at least one processor to:
update use state information of the image forming apparatus;
extract partial information from the agreement information and the use state information; and
perform display of the partial information on a function selection screen for selecting a function of the image forming apparatus.

2. The image forming apparatus according to claim 1, wherein the function selection screen is a home screen of the image forming apparatus.

3. The image forming apparatus according to claim 1, wherein the at least one processor further performs display of the partial information on a screen shifted from the function selection screen in response to an operation on the image forming apparatus.

4. The image forming apparatus according to claim 1, wherein the at least one processor further performs display of detailed information in addition to the partial information with respect to the agreement information or the use state information, in a case where a predetermined operation is performed on the image forming apparatus.

5. The image forming apparatus according to claim 4, wherein the predetermined operation is an operation of selecting a first display area for displaying the partial information.

6. The image forming apparatus according to claim 1, wherein the function include a copy function.

7. The image forming apparatus according to claim 1, wherein the at least one processor further
determines a login account of the image forming apparatus,
acquires the agreement information associated with the login account from the server, and
extracts the partial information from the use state information and the agreement information associated with the login account.

8. The image forming apparatus according to claim 7, wherein in a case where the login account is a predetermined account, the at least one processor performs display of the partial information.

9. The image forming apparatus according to claim 7, wherein the at least one processor further performs display of information common to the plurality of agreement information items regardless of the login account.

10. The image forming apparatus according to claim 1, wherein the at least one processor further extracts the partial information from the agreement information and the use state information according to a display setting set for the agreement information.

11. The image forming apparatus according to claim 1, wherein in a second display area for displaying other information different from the partial information, the at least one processor further performs display of the partial information and the other information while switching therebetween.

12. The image forming apparatus according to claim 1, wherein in a case where the image forming apparatus satisfies a popup condition, the at least one processor further performs display of the partial information on a popup screen.

13. The image forming apparatus according to claim 12, wherein the popup condition is that the image forming apparatus is powered on, that the image forming apparatus is returned from a sleep state, or that login is performed on the image forming apparatus.

14. The image forming apparatus according to claim 13, wherein in a case where the image forming apparatus satisfies a partial display condition, the at least one processor further performs display of the partial information.

15. The image forming apparatus according to claim 1, wherein the partial information is information concerning the number of printed sheets of the image forming apparatus.

16. The image forming apparatus according to claim 1, wherein the at least one processor further acquires the agreement information from the server during the display of the partial information.

17. A system comprising:
a server, and
an image forming apparatus that receives provision of a service according to agreement information managed by the server,
wherein the server comprises a transmission unit configured to transmit the agreement information to the image forming apparatus, and
wherein the image forming apparatus comprises:
a reception unit configured to receive the agreement information from the server;
an update unit configured to update use state information of the image forming apparatus;
an extraction unit configured to extract partial information from the agreement information and the use state information; and
a display unit configured to display the partial information on a function selection screen for selecting a function of the image forming apparatus.

18. A method of controlling an image forming apparatus that acquires agreement information managed by a server and receives provision of a service according to the agreement information, comprising:
updating use state information of the image forming apparatus;
extracting partial information from the agreement information and the use state information; and
displaying the partial information on a function selection screen for selecting a function of the image forming apparatus.

19. A non-transitory computer-readable storage medium storing a program for causing a computer to execute a method of controlling an image forming apparatus that acquires agreement information managed by a server and receives provision of a service according to the agreement information, the method comprising:
updating use state information of the image forming apparatus;
extracting partial information from the agreement information and the use state information; and
displaying the partial information on a function selection screen for selecting a function of the image forming apparatus.
